(19) United States
(12) Patent Application Publication
(10) Pub. No.: US 2024/0288864 A1
(43) Pub. Date: Aug. 29, 2024

(54) Method and System for Drone Localization and Planning

(71) Applicant: Corvus Robotics, Inc., Mountain View, CA (US)

(72) Inventors: Leonardo Lai, Groningen (NL); Alexander Joseph Mikhalev, Fremont, CA (US); Mohammed Hanif Kabir, Mountain View, CA (US); Swapneel Uday Naphade, Mountain View, CA (US); Kartik Prakash, Mountain View, CA (US); Jonathan James Sandau, San Jose, CA (US); Disha Sarawgi, Mountain View, CA (US); Yue Wu, Sunnyvale, CA (US)

(21) Appl. No.: 18/175,777

(22) Filed: Feb. 28, 2023

(51) Int. Cl. G05D 1/00; B64U 10/00; G01C 21/20; G05D 1/10; G06Q 10/087; G08G 5/00

(52) U.S. Cl. CPC G05D 1/0094; B64U 10/00; G01C 21/206; G06Q 10/087; G08G 5/0034; G08G 5/0069; B64U 2101/70; B64U 2201/10

(57) ABSTRACT

A localization and flight planning system for a drone performing inventory management is disclosed. The system includes a drone with sensors, one or more machine-learned models, and controllers. The system is configured to obtain data indicating inventory items to be scanned by the drone. The sensors are configured to obtain sensor data indicative of a warehouse infrastructure within the warehouse environment. The system is further configured to identify objects of interest based on the sensor data and store information associated with the objects of interest in an onboard memory. The one or more models are configured to generate one or more location anchors based on the objects of interest and localize the drone within the warehouse environment. The system may be further configured to generate flight plans based on localizing drone within the warehouse. The controllers may be configured to control the drone by executing the flight plans.

### BACKGROUND

Effective supply chain planning relies on effective management of warehouse inventory. Many warehouses have a dedicated team whose job is to walk around the warehouse scanning boxes to maintain the most up to date location of inventory. This manual process is not only inefficient but is subject to human error in scanning and updating the warehouse inventory. In addition, workers frequently experience difficulties locating specific items and even when items are located, an obscured bar code can prevent accurate inventory calculations.

### SUMMARY

The present disclosure is directed to techniques for autonomous drone localization and flight planning within a warehouse. localization techniques according to the present disclosure can provide for improved drone localization by using models to identify objects of interest within a warehouse's repetitive environment to generate location anchors and accurately associate the location anchors with a location within a warehouse.

For example, when an autonomous drone comes online, an autonomy system can determine a current location by receiving location data from a landing pad where the autonomous drone is docked. As the autonomous drone proceeds to execute its inventory mission and flies throughout the warehouse, an autonomy system can perceive its environment by obtaining sensor data indicative of the autonomous drone's location within a warehouse. The sensor data can be captured over time and can include a plurality of image frames depicting objects within the warehouse.

The autonomous drone can utilize the sensor data to determine an object in the surrounding environment of the autonomous drone is an object of interest. For example, a machine-learned object detection model can analyze a respective image frame to detect whether or not the object depicted is an object of interest. Example objects of interests can include any object in a warehouse that possesses physical characteristics (e.g., height, width, depth, orientation) which can be associated with a specific location within the warehouse. Objects of interests can include warehouse infrastructure including, for example, landing pads, inventory shelving units (e.g., uprights, beams), other warehouse infrastructure, or any other stationary object. In some implementations, objects of interest can also include mobile objects. Objects which are identified as not representing an object of interest can be filtered out of the downstream localization analysis.

If the object is an object of interest, the object detection model can generate a location anchor to associate the object of interest with a specific location within the warehouse. The object detection model can be trained to determine a specific location within a warehouse each time that the location anchor is perceived by the autonomous drone. Location anchors can be an identifier that provides specific location data (e.g., a position on a warehouse layout) to an autonomous drone when perceived by the autonomous drone's object detection system. For example, the autonomous drone can perceive an object with physical characteristics of an inventory shelving unit (or a portion thereof). The object detection model can determine the object is an inventory shelving unit and is an object of interest. The object detection model can generate a location anchor for the inventory shelving unit at the position within the warehouse where it was perceived by the autonomous drone. Each time the autonomous drone perceives the inventory shelving unit, the autonomous drone can determine its location within the warehouse based on the location anchor.

Location anchors can provide location data with respect to a location of an autonomous drone within a warehouse. For instance, a location of the location anchor can be associated with a dimensional layout of the warehouse. For example, the object detection model can determine an object perceived by the autonomous drone is near a corner of the warehouse. The object detection model can determine that the object located near a corner of the warehouse is an object of interest and generate a location anchor for the object located in a specific corner of the warehouse. In some examples, the autonomous drone can determine a location anchor is in a specific corner of the warehouse by determining the distance from a known location such as a landing pad or another location anchor. In some examples, the object detection model can associate a location anchor with a specific corner of the warehouse based on a comparison between the physical characteristics of the object of interest and an associated location of an object on the dimensional layout of the warehouse environment. In some examples, the object detection model can associate a location anchor with a dimensional layout of the warehouse by comparing the object of interest's dimensions with the dimensions of an object on the dimensional layout of the warehouse environment.

A flight planning model can receive location anchors as input for generating the flight path of the autonomous drone. For example, the flight planning model can determine the most optimal path to travel from the autonomous drone's current location to a target location by determining the distance between multiple location anchors. For instance, the flight planning model can be trained to determine that the distance between location anchor 1 and location anchor 2 is a shorter flight distance than the distance between location anchor 1 and location anchor 3. In some examples, a location anchor can be configured to identify a static obstacle (e.g., floor pallet, parked machinery, etc.). In some examples, the flight planning model can generate a new flight plan to avoid a location anchor which increases travel distance for the autonomous drone. In some examples, the flight planning model can generate modified flight plans to locate misslotted inventory items. In other examples, the flight planning model can generate a modified flight plan to rescan missed inventory items.

In some examples, the flight planning model can use location anchors and a dimensional layout of the warehouse environment to generate a flight plan for the autonomous drone. For instance, the flight planning model can receive as input location anchors associated with positions on a dimensional layout of the warehouse. In some examples, the flight planning model can determine the most optimal flight plan from the autonomous drone's current location to a target location by determining the distance between multiple location anchors on the dimensional layout. In some examples, the flight planning model can generate a flight plan which deviates from previous flight plans based on associated location anchors on the dimensional layout. In some examples, the flight planning model can generate a more efficient flight plan which does not include associated location anchors on the dimensional layout. In other examples, where flight plans do not include associated location anchors on the dimensional layout, the object detection model can generate location anchors and associate the location anchors on the dimensional layout for future use.

The autonomous drone can perform various actions based on the detection of a location anchor within its surroundings. For example, the autonomous drone can update a flight plan based on the detection of a location anchor. In some examples, the autonomous drone can communicate the location of a location anchor to other autonomous drones within the warehouse environment. Moreover, the autonomous drone's autonomy system can strategize about how best to traverse and navigate the warehouse environment by considering decision-level options for movement (e.g., re-route/not re-route the autonomous drone, etc.). If necessary, the autonomous drone can be remotely controlled to navigate to an alternate flight plan in response to detecting a location anchor.

The localization and planning techniques of the present disclosure can provide a number of technical benefits for improvements of the performance of the autonomous drone. For instance, by detecting objects of interests and creating location anchors using the described approach, the autonomous drone is able to more effectively and consistently determine the autonomous drone's location within a warehouse decreasing on-board computing resources over time. For example, the autonomous drone can focus on more discrete tasks such as active avoidance, and barcode tracking. This helps to reduce the complexity of training or building heuristics for the autonomy system. Furthermore, the described localization and planning techniques allow an autonomous drone to maximize battery life while improving the efficiency of inventory scanning. For example, as the autonomous drone generates location anchors the autonomous drone will be able to execute future missions more seamlessly and efficiently through the improved localization and optimized flight planning.

For example, in an aspect, the present disclosure provides an example method for autonomous drone localizing and planning. In some implementations, the example method includes obtaining mission data indicative of one or more inventory items to be scanned by an autonomous drone. In some implementations, the example method includes obtaining sensor data indicative of an object of interest within a warehouse environment of the autonomous drone. In some implementations, the example method includes generating a location anchor based on the object of interest, wherein the object of interest comprises warehouse infrastructure, and wherein the location anchor is associated with a location within the warehouse environment. In some implementations, the example method includes determining a location of the autonomous drone within the warehouse based on the location anchor. In some implementations, the example method includes generating a flight plan for the autonomous drone based on the mission data, the location anchor, and location of the autonomous drone.

In some implementations, the mission data is obtained from a drone landing pad.

In some implementations, the mission data is indicative of a region of the warehouse.

In some implementations, the example method includes obtaining map data, wherein the map data is indicative of a dimensional layout of the warehouse. In some implementations, the example method includes determining a position on the dimensional layout of the warehouse that corresponds to the location anchor. In some implementations, the example method includes determining the location of the autonomous drone based at least in part on the location anchor and dimensional layout of the warehouse.

In some implementations, the example method of generating a location anchor based on the object of interest includes determining, using a machine-learned model, physical characteristics associated with an object in the sensor data. In some implementations, the example method of generating a location anchor based on the object of interest includes determining, using the machine-learned, the object in the sensor data is the object of interest based on the physical characteristics. In some implementations, the example method of generating a location anchor based on the object of interest includes determining, using the machine-learned model, a location of the object of interest.

In some implementations, the example method of generating the flight plan further includes, generating, using the location anchor, an initial trajectory of the autonomous drone wherein the initial trajectory is indicative of a first direction of travel based on the location anchor.

In some implementations the object of interest is a portion of an inventory rack in the warehouse environment.

In some implementations, the example method includes obtaining inventory data by scanning inventory items, wherein the inventory items are indicative of the mission data.

In some implementations, obtaining inventory data by scanning inventory items includes obtaining, using a first camera, first sensor data indicative of at least one of the one or more inventory items, wherein the first camera includes a wide angle view of the inventory items. In some implementations, obtaining inventory data by scanning inventory items includes obtaining, using a second camera, second sensor data indicative of a barcode on the inventory items, wherein the second camera includes a narrow angle view of the barcode. In some implementations, obtaining inventory data by scanning inventory items includes determining that an inventory item is associated with a misslot or a rescan based on the first and second sensor data.

In some implementations, the example method includes generating a dock flight plan, wherein the dock flight plan is indicative of the autonomous drone navigating to a landing pad. In some implementations, the example method includes transmitting updated mission data to the landing pad, wherein the updated mission data is indicative of the inventory items scanned by the autonomous drone.

In some implementations, the mission data is obtained by a first autonomous drone and a second autonomous drone from the landing pad.

For example, in an aspect, the present disclosure provides an example computing system for an autonomous drone. In some implementations, the example computing system includes one or more processors and one or more computer-readable media storing instructions that are executable to cause the computing system to perform operations. In some implementations the example operations include obtaining mission data indicative of one or more inventory items to be scanned by the autonomous drone. In some implementations, the example operations include obtaining sensor data indicative of an object of interest within a warehouse environment of the autonomous drone. In some implementations, the example operations include generating a location anchor based on the object of interest, wherein the object of interest includes warehouse infrastructure, and wherein the location anchor is associated with a location within the warehouse environment. In some implementations, the example operations include determining the location of the autonomous drone within the warehouse based on the location anchor. In some implementations, the example operations include generating a flight plan based on the mission data, the location anchor, and the location of the autonomous drone.

In some implementations, the mission data is obtained from a drone landing pad.

In some implementations, the mission data is associated with of a region of the warehouse.

In some implementations, determining the location of the autonomous drone includes obtaining map data, wherein the map data is indicative of a dimensional layout of the warehouse.

In some implementations, determining the location of the autonomous drone includes determining a position on the dimensional layout of the warehouse that corresponds to the location anchor.

In some implementations, determining the location of the autonomous drone includes determining the location of the autonomous drone based on the location anchor and a dimensional layout of the warehouse.

In some implementations, generating a location anchor based on the object of interest includes determining, using a machine-learned model, physical characteristics associated with an object in the sensor data. In some implementations, generating a location anchor based on the object of interest includes determining, using the machine-learned, the object in the sensor data is the object of interest based at least in part on the physical characteristics. In some implementations, generating a location anchor based on the object of interest includes determining, using the machine-learned model, a location of the object of interest.

In some implementations, generating a flight plan includes generating, using the location anchor, an initial trajectory of the autonomous drone wherein the initial trajectory is indicative of a first direction of travel based on the location anchor.

In some implementations, the object of interest is a portion of an inventory shelving unit in the warehouse environment.

In some implementations, the example operations include obtaining inventory data by scanning inventory items, wherein the inventory items are indicative of the mission data.

In some implementations, obtaining inventory data by scanning inventory items includes obtaining, using a first camera, first sensor data indicative of at least one of the one or more inventory items, wherein the first camera includes a wide angle view of the inventory items. In some implementations, the example operation obtaining inventory data by scanning inventory items includes obtaining, using a second camera, second sensor data indicative of a barcode on the inventory items, wherein the second camera includes a narrow angle view of the barcode. In some implementations, obtaining inventory data by scanning inventory items includes determining that an inventory item is associated with a misslot or rescan based on the first and second sensor data.

In some implementations, the example operations include generating a dock flight plan, wherein the dock flight plan is indicative of the autonomous drone navigating to a landing pad. In some implementations, the example operations include transmitting updated mission data to the landing pad, wherein the updated mission data is indicative of the inventory items scanned by the autonomous drone.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 is a block diagram of an example computing system of an autonomous drone, according to some implementations of the present disclosure;

FIG. 2 is a block diagram of an example computing ecosystem of an autonomous drone and a landing pad, according to some implementations of the present disclosure;

FIG. 3 is a representation of an example autonomous drone flight plan through a warehouse environment, according to some implementations of the present disclosure;

FIG. 4A is a representation of an example inventory item, according to some implementations of the present disclosure;

FIG. 4B is a representation of an example inventory barcode, according to some implementations of the present disclosure;

FIG. 5 is a representation of an example autonomous drone flight plan to scan inventory, according to some implementations of the present disclosure;

FIG. 6A is representation of an example dimensional layout of a warehouse, according to some implementations of the present disclosure;

FIG. 6B is a representation of example dimensions of a warehouse inventory shelving unit, according to some implementations of the present disclosure;

FIG. 7 is a block diagram of an example computing ecosystem, according to some implementations of the present disclosure;

FIG. 8 is a block diagram of an example computing system for autonomous drone localization and flight planning, according to some implementations of the present disclosure;

FIG. 9 is a block diagram of an example computing system for localizing an autonomous drone, according to some implementations of the present disclosure;

FIG. 10 is a block diagram of an example computing system for autonomous drone flight planning according to some implementations of the present disclosure;

FIG. 11A-11C are example object detections, according to some implementations of the present disclosure;

FIG. 12 is a flow chart of an example method for autonomous drone localization using location anchors, according to some implementations of the present disclosure;

FIG. 13 is a representation of example landing pads accommodating multiple autonomous drones in a warehouse.

### DETAILED DESCRIPTION

The following describes the technology of this disclosure within the context of an autonomous drone within a warehouse environment for example purposes only. As described herein, the technology described herein is not limited to an autonomous drone and can be implemented for or within other autonomous vehicles and other computing systems in one or more other types of environments.

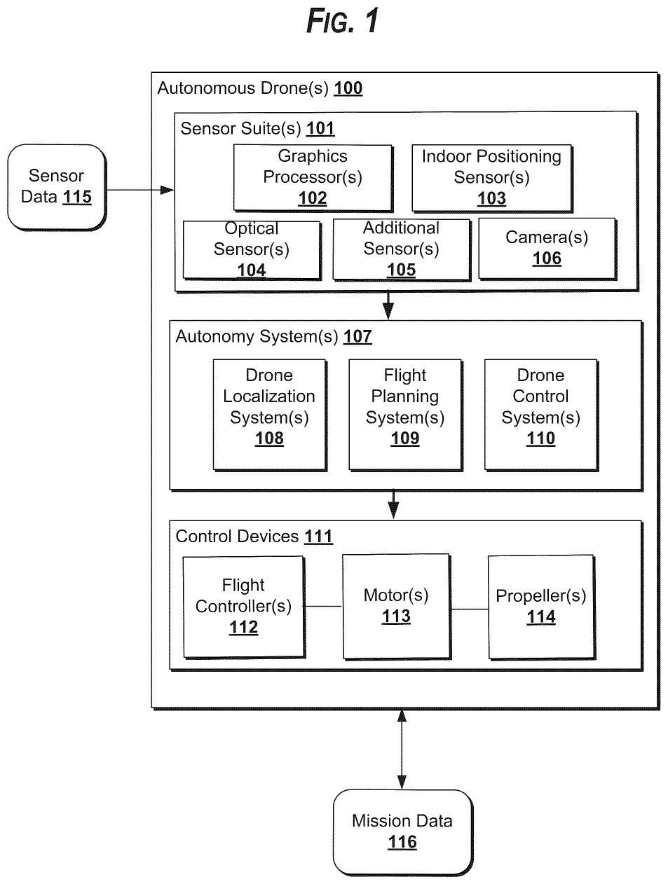

With reference to FIGS. 1-13, example embodiments of the present disclosure are discussed in further detail. FIG. 1 is a block diagram of an example computing system of an autonomous drone according to example implementations of the present disclosure. The example autonomous drone 100 can include a number of subsystems for performing various operations. The subsystems may include a sensor suite 101, autonomy system 107, and control devices 111. The autonomous drone 100 may be any type of aerial vehicle configured to operate within a warehouse environment. For example, the autonomous drone 100 may be a vehicle configured to autonomously perceive and operate within the warehouse environment. This can include multi-rotor drones, fixed-wing drones, single-rotor drones, or fixed-wing hybrid VTOL (e.g., vertical take-off landing) drones. The autonomous drone may be an autonomous vehicle that can control, be connected to, or be otherwise associated with implements, attachments, and/or accessories for scanning inventory items within a warehouse environment.

The autonomy system 107 can be implemented by one or more onboard computing devices. This can include one or more processors and one or more memory devices. The one or more memory devices can store instructions executable by the one or more processors to cause the one or more processors to perform operations or functions associated with the subsystems. The computing resources of the autonomy system 107 can be shared among its subsystems, or a subsystem can have a set of dedicated computing resources.

The example autonomous drone 100 may include a sensor suite 101 which can include different subsystems for performing various sensory operations. The subsystems may include graphics processors 102, indoor positioning sensors 103, optical sensors 104, additional sensors 105 (e.g., LiDAR, RADAR, laser scanner, photodetector array, etc.), and cameras 106 (e.g., wide angle cameras, narrow angle cameras, etc.).

The graphics processor 102 can perform image processing of captured images; indoor positioning sensors 103 can include a variety of sensors (e.g., camera vision based SLAM positioning system employing one or more monocular cameras, one or more stereoscopic camera, one or more laser depth sensors, one or more LIDAR devices, laser and/or ultrasonic rangefinders, an inertial sensor based positioning system, an RF/WIFI/Bluetooth triangulation based sensor system, or the like).

In some examples, the graphics processor 102 can include a graphics processing unit (GPU). In some examples, the graphics processing unit can include a graphics card (e.g., board that incorporates the graphics processing unit). In some examples, the graphics card can be integrated into a computing system of the autonomous drone 100.

In some examples, the graphics processor 102 can accelerate real-time 3D graphics applications. For example, the graphics processor 102 can accelerate real-time 3D graphics for the machine-learned models of an autonomous drone 100. In some examples, the graphics processor 102 can process sensor data 115 captured by an autonomous drone 100 as it flies throughout a warehouse.

Optical sensors 104 can detect inventory identifiers (e.g., inventory barcodes) and implement optical character recognition (OCR), machine learning, computer vision, or any other image processing algorithm(s)), any combination thereof. In some examples, optical sensors 104 can be electronic detectors that convert or change light into an electric signal. For example, optical sensors 104 can utilize electric signals to identify inventory items through obtaining an image of a barcode. In some examples, optical sensors 104 can be integrated into a camera 106. In other examples, optical sensors 104 can be a standalone sensor.

Additional sensors 105 can include a variety of sensors (e.g. temperature sensors, inertial sensors, altitude detectors, LIDAR devices, laser depth sensors, radar/sonar devices, wireless receivers/transceivers, RFID detectors, etc.).

In some examples, cameras 106 can include a varied field of view. In some examples, a wider field of view camera 106 can observe more of the surrounding environment. In some examples, a narrower field of view camera 106 can observe less of the surrounding environment. In other examples, the camera lens, focal length, and sensor size can determine the field of view for the camera 106. In some examples, the field of view for a camera 106 can be static (e.g., does not change). In other examples, the field of view for a camera 106 can be dynamic (e.g., can be automatically adjusted).

Cameras 106 can collect wide field of view and narrow field of view images for processing. In the example autonomous drone 100, the sensor suite 101 can obtain any sensor data 115 that describes the surrounding warehouse environment of the autonomous drone 100. The computing resources of the sensor suite 101 can be shared among its subsystems, or a subsystem can have a set of dedicated computing resources.

The example autonomous drone 100 may include an autonomy system 107 which can include different subsystems for performing various autonomy operations. The autonomy operations can include perceiving the surrounding environment of the autonomous drone 100 and autonomously planning the drone's motion through the environment, without manual human input. The subsystems of the autonomy system 107 can include a drone localization system 108, flight planning system 109, and drone control system 110.

The autonomy system 107 can be implemented by one or more onboard computing devices. This can include one or more processors and one or more memory devices. The one or more memory devices can store instructions executable by the one or more processors to cause the one or more processors to perform operations or functions associated with the subsystems. The computing resources of the autonomy system 107 can be shared among its subsystems, or a subsystem can have a set of dedicated computing resources.

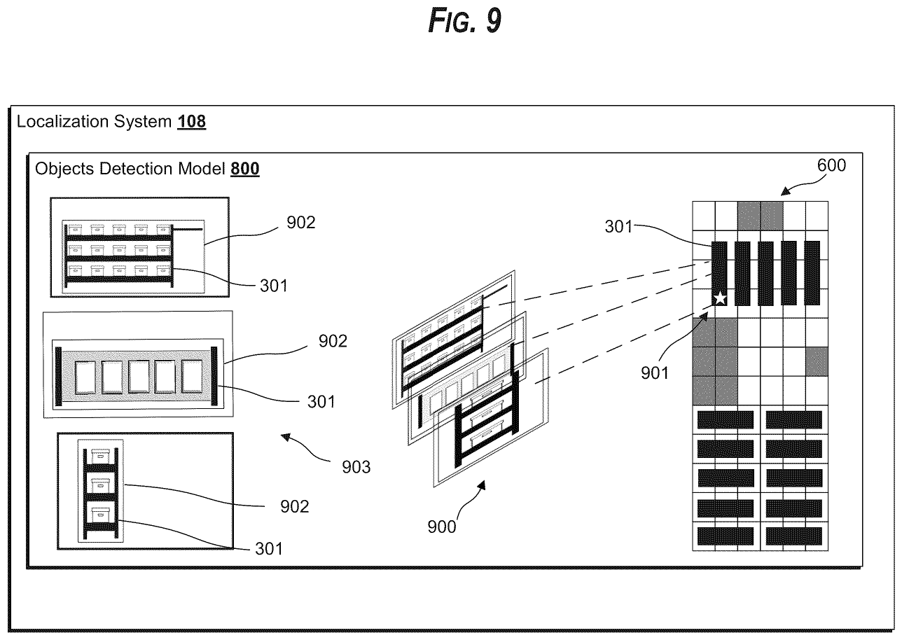

The drone localization system 108 can determine the location of the autonomous drone 100 within the warehouse environment. In some examples, the localization system 108 of the autonomous drone 100 can pinpoint its exact location within the warehouse environment based on determining the location of an object in the immediate vicinity of the autonomous drone 100. In some examples, the localization system 108 can determine the location of the autonomous drone 100 by comparing the distance of the autonomous drone 100 from an object identified in the surrounding warehouse environment. An example of the autonomous drone 100 localizing based on identifying and determining the location of an object is shown in FIG. 9

The flight planning system 109 can determine a trajectory for the autonomous drone 100. A flight plan can include one or more trajectories (e.g., flight trajectories) that indicate a path for the autonomous drone 100 to follow. A trajectory can be of a certain length or time range. The length or time range can be defined by the computational planning horizon of the flight planning system 109. A trajectory can be defined by one or more waypoints (with associated coordinates). The way points(s) can be future locations(s) for the autonomous drone 100. The flight plans can be continuously generated, updated, and considered by the autonomy system 107.

The drone control system 110 can translate the trajectory into vehicle controls for controlling the autonomous drone 100. For example, the autonomous drone 100 may include control devices 111 which can include different subsystems for performing various flight control operations. The subsystems may include flight controllers 112, motors 113, and propellers 114.

In some examples, the drone control system 110 can translate the trajectory into electrical signals. In some examples, the control devices 111 can receive the electrical signals from the drone control system 110. The control devices 111 can be configured to implement the translated controls (e.g., electrical signals) from the drone control system 110. The flight controller 112 can implement operations to drive the motors 113 and propellers 114. In some examples, the autonomy system 107 can output instructions that can be received by the control devices 111. In some examples, the control devices 111 can translate the instructions into control signals to control the flight controllers 112, motors 113, and propellers 114.

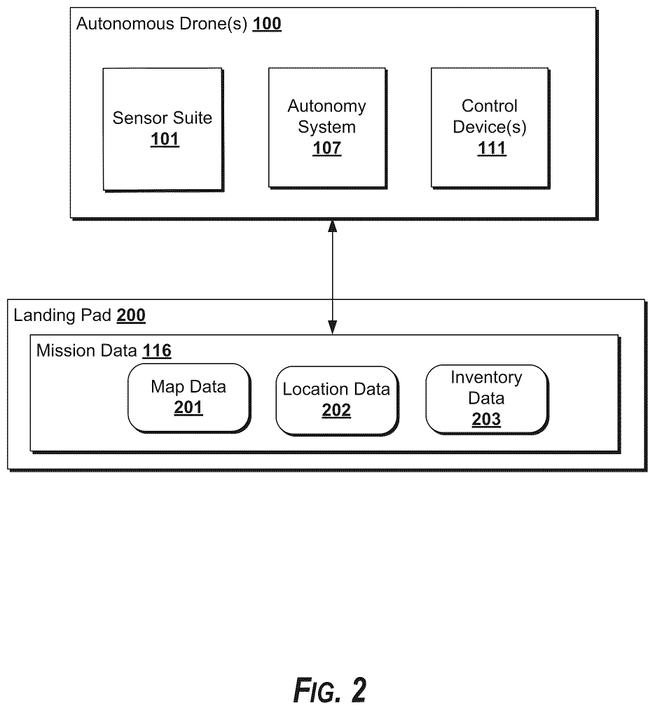

Mission data 116 can be transferred to and from the autonomous drone 100 with data and instructions for warehouse inventorying. Mission data 116 can be processed by the autonomous drone 100 and its subsystems as input to the autonomous drone 100 for autonomous flight operations and the warehouse inventory management process. The types of information included in mission data 116 and the sources of the mission data 116 are further described herein with reference to FIG. 2.

As further described, the autonomous drone 100 can obtain sensor data 115 through the sensor suite 101 and utilize its autonomy system 107 to detect objects and plan its flight plan to navigate through the warehouse environment. The autonomy system 107 can generate control outputs for controlling the autonomous drone 100 (e.g., through drone control systems 110, control devices 111, etc.) based on sensor data 115, mission data 116, or other data.

FIG. 2 is a block diagram of an example computing ecosystem for an example autonomous drone and an example landing pad, according to some implementations of the present disclosure. As further described herein, the autonomous drone 100 can receive or transmit mission data 116 which include data and instructions for autonomous flight operations and the warehouse inventory management process. The mission data 116 can be received or transmitted from a landing pad 200. Landing pads 200 can be a landing surface for an autonomous drone 100 positioned within the warehouse environment.

The example landing pad 200 can be any landing surface suitable for supporting an autonomous drone 100. In some examples, the landing pad 200 is affixed to an inventory shelving unit. In some examples, the landing pad 200 is affixed to other warehouse infrastructure. The landing pad 200 can be configured to provide charging power to the autonomous drone 100 while the autonomous drone 100 is docked on the landing pad 200. In some examples, the landing pad 200 can provide an accommodating physical shape to one or more portions of autonomous drone 100 to allow for easier landing and docking. In other examples, the landing pad 200 can include visual identifiers to allow for easier detection of the landing pad 200 by an autonomous drone 100.

In an example, mission data 116 can be received or transmitted between the autonomous drone 100 and landing pad 200. For example, when a new inventory mission has been generated, the landing pad 200 can transmit mission data 116 to an autonomous drone 100 that is docked on the landing pad 200. In some examples, an autonomous drone 100 that has completed an inventory mission can dock on a landing pad 200 and transmit updated mission data 116 (e.g., indicating inventory items that were scanned and inventory items that were not found) to the landing pad 200, as will be further described herein. In some examples, an autonomous drone 100 can dock on a landing pad 200 prior to completing an inventory mission and transmit updated mission data 116 to the landing pad 200.

Mission data 116 can include different types of datasets associated with warehouse inventorying. The datasets can include map data 201, location data 202, inventory data 203. The map data 201 can include a dimensional (e.g., 2D, 3D, 4D, etc.) layout of the warehouse environment. In some examples, the map data 201 can be generated by manually mapping the layout of the warehouse using LiDAR and camera sensors. In some examples, map data 201 can be generated by manually flying a drone throughout the warehouse environment. In some examples, the map data 201 can be generated by processing a facility map of the warehouse which includes dimensional measurements of the warehouse and warehouse infrastructure. Warehouse infrastructure can include any stationary or mobile object within a warehouse. In some examples warehouse infrastructure can include inventory shelving units, large ceiling fans, cranes or hoists, integrated dock levelers, work benches, etc.

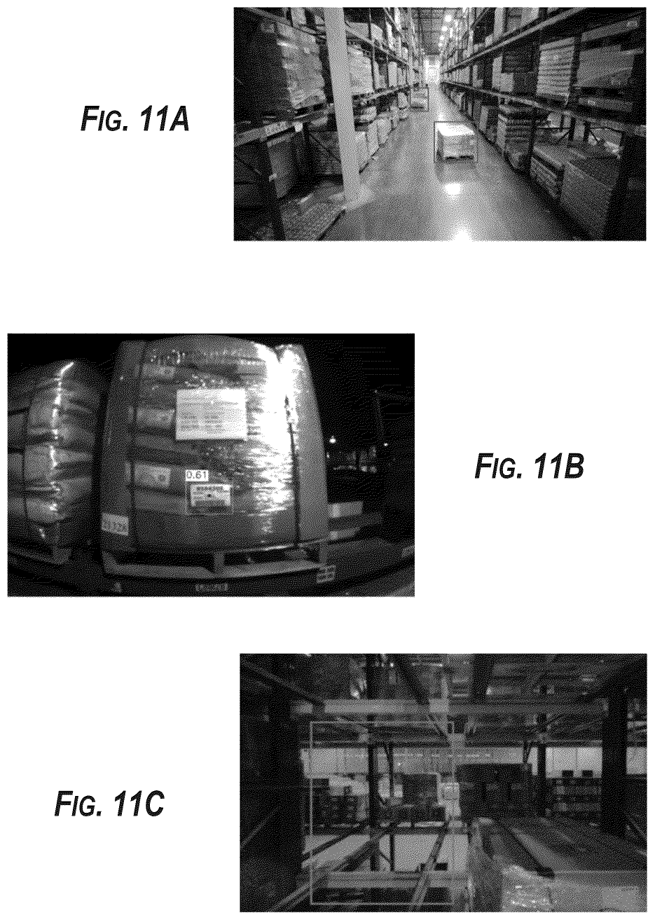

In some examples, map data 201 can include information indicative of one or more obstacles within the warehouse environment. For example, the map data 201 may encode the locations of one or more obstacles. This information may be included as an “obstacle map”. An obstacle map can include known or perceived obstacles which can disrupt a flight plan for an autonomous drone 100. Obstacles can include pallets, utility carts or dollies, totes, bins, etc. FIG. 11A illustrates example floor pallets that can be an obstacle for an autonomous drone 100.

In some examples, the obstacle map can be generated by manually mapping the layout of the warehouse using LiDAR, camera, or other sensors. In some examples, the obstacle map can be generated by processing a facility map of the warehouse which includes dimensional measurements of warehouse infrastructure. In some examples, an obstacle map can be updated by an autonomous drone 100 that perceived the obstacle during an inventory mission. In other examples, an obstacle map can be updated by an autonomous drone 100 that perceived a removed obstacle.

Location data 202 can include a current location of the landing pad 200. In some examples, the autonomous drone 100 can be docked on a landing pad 200. For example, when the autonomous drone 100 is docked on a landing pad 200, mission data 116 can be transmitted between the autonomous drone 100 and landing pad 200 upon contact. In some examples, the landing pad 200 can charge the autonomous drone 100 while mission data 116 is being transmitted. In some example implementations, when an autonomous drone 100 comes online, and upon initializing sensors, location data 202 can be transmitted to the autonomous drone 100 to provide a current location of the autonomous drone 100. In some example implementations, the current location of the autonomous drone 100 is the location of the landing pad 200 within the warehouse environment.

In some examples, the location data 202 can include the region of the warehouse where inventory items are located. For example, the location data 202 can include the location of a set of shelves or inventory shelving units where inventory items are located. In some examples, the location data 202 can be an associated location on a dimensional layout of the warehouse. In some example implementations, the location data 202 can include map data 201. In other examples, location data 202 can include the location of obstacles within the warehouse environment.

Inventory data 203 can include relevant inventory items to be scanned by the autonomous drone 100. For example, inventory data 203 can include a list of inventory items expected to be within the warehouse. In some implementations, inventory data 203 can include data indicative of where an inventory item is expected to be located on specific inventory shelving unit. In some examples, the inventory data 203 can be a database table including a plurality of rows and columns. In some examples, the database table can include the inventory shelving unit where the inventory item should be located, a description of the inventory item, the barcode identifier, etc., in the columns and rows. In some examples, the database table can be compressed. In other examples, the database table can be updated as new inventory data (e.g., inventory items leave or enter the warehouse) is generated.

In other examples, inventory data 203 can include a list of missing inventory items. Missing inventory items can include inventory items which cannot be found by the autonomous drone 100 in their expected location. In some examples, missing inventory items may have already left the warehouse. In other examples, missing inventory items may be lost.

FIG. 11C illustrates a missing inventory item. In some examples, inventory data 203 can include map data 201 and location data 202. In other examples, missing inventory items can be included in map data 201. In some examples, missing inventory items can update inventory data 203. In some examples, missing inventory items can update location data 202.

Inventory data 203 can be generated by a warehouse inventory management software. For example, warehouse employees can update an inventory management software with current inventory items. In some examples, the inventory management software can track the volume and location of inventory items within the warehouse. In some examples, the inventory management software can be updated as inventory items enter and leave the warehouse. In some examples, inventory data 203 can synchronize with the inventory management software to maintain accurate inventory levels. In other examples, inventory data 203 can update the inventory levels in the inventory management software.

Inventory data 203 can be updated by an autonomous drone 100. For example, as the autonomous drone 100 flies throughout the warehouse to scan inventory, some inventory items which should be located within the warehouse may no longer be located within the warehouse. When inventory items are not found, inventory data 203 can be updated to reflect the current stock levels of current inventory within the warehouse. In some examples, inventory items may be located in a different location than the inventory data 203. When inventory items are scanned in a different location than the inventory data 203, the inventory data 203 can be updated to reflect the current location of the inventory items. In some examples, an inventory management system can be updated by the inventory data 203.

In some examples, inventory data 203 can be updated to reflect misscanned inventory. Misscanned inventory can include inventory items which have an unreadable or obscure barcode. In some examples, inventory data 203 can include a count and location of miscanned inventory. In some examples, an inventory management system can be updated by the inventory data 203. In some implementations, inventory data 203 can be updated to reflect misslots. Misslots can include inventory which is located in a different location (e.g., slot) than what was indicated in the inventory data 203. In some examples, a misslot can include inventory items in the wrong location (e.g., slot).

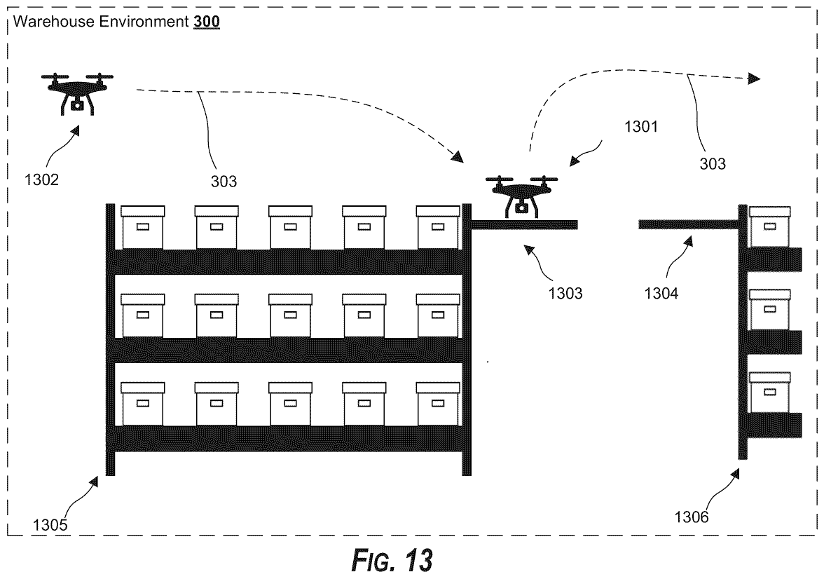

As further described herein, the autonomous drone 100 and landing pad 200 can exchange mission data before, during, and after an autonomous drone 100 has completed its inventory mission. In some examples, a warehouse can utilize multiple autonomous drones 100 and multiple landing pads 200 to scan an entire warehouse. In some examples, multiple autonomous drones 100 can utilize different or multiple landing pads 200 to complete its inventory mission. In some examples, multiple autonomous drones 100 can utilize the same landing pad 200. FIG. 13 illustrates an example of multiple autonomous drones 100 utilizing the same landing pad 200.

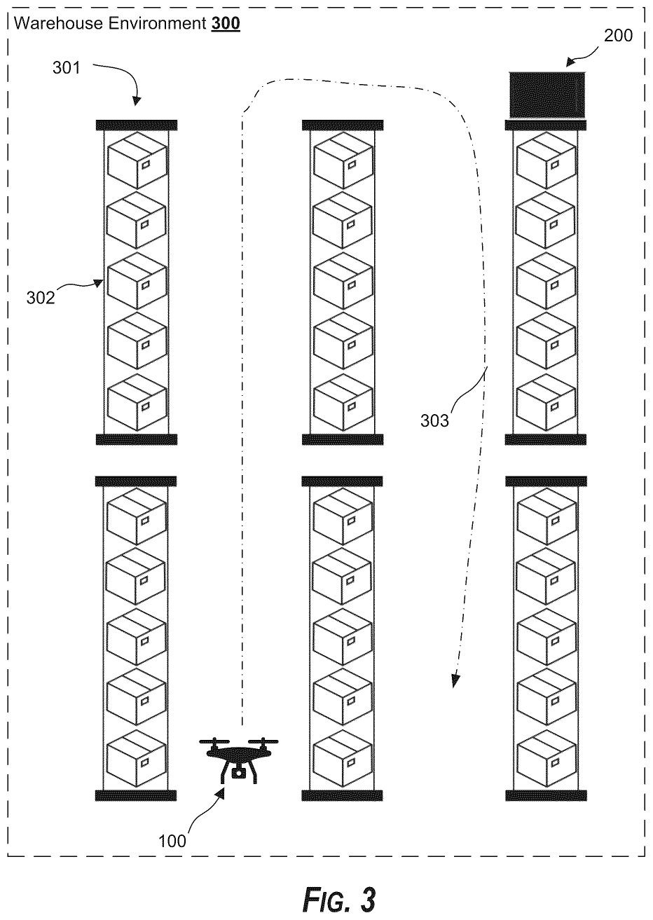

FIG. 3 is a representation of an example autonomous drone flight plan through a warehouse environment, according to some implementations of the present disclosure. As further described herein, the autonomous drone 100 can navigate a warehouse environment 300 to scan inventory items 302. A warehouse environment 300 can be any building or structure where manufactured goods or raw materials may be stored. In some examples, the warehouse environment 300 may include an indoor environment (e.g., within one or more facilities, etc.) or an outdoor environment. An indoor environment, for example, may be an environment enclosed by a structure such as a building (e.g., a service depot, maintenance location, manufacturing facility, etc.). An outdoor environment, for example, may be one or more areas in the outside world such as, for example, one or more rural areas suitable for storage of manufactured goods or raw materials (e.g., supply chain port, lumber yards, etc.).

The warehouse environment 300 may include inventory shelving units 301 (e.g., inventory storage racks) which store inventory items 302. The inventory shelving units 301 may be positioned in a predictable and repeatable pattern throughout the warehouse environment 300. In some examples, the inventory shelving units 301 can be positioned in rows. In other examples, the inventory shelving units 301 can be positioned adjacent to each other. In some examples the inventory shelving units 301 can be stacked on each other. In some examples, the inventory shelving units 301 can be positioned to allow for people or autonomous drones 100 to navigate the warehouse environment 300.

The inventory shelving units 301 can be of standard warehouse rack size or of custom size. In some examples, the inventory shelving units 301 can be 8-feet, 10-feet, 12-feet, 16-feet, and 20-feet upright. In other examples, the inventory shelving units 301 can be of a custom size (e.g., 11-feet, 11.5-feet, etc.). In some examples, the inventory shelving units 301 can be based on the measure and height of inventory pallets. In other examples, the inventory shelving units 301 can be based on the racking beam size.

The inventory shelving units 301 can store warehouse inventory items 302 on its shelves. An inventory item 302 can be any manufactured product or raw material which is being stored in the warehouse environment 300. For example, inventory items 302 can include boxes which contain a manufactured good or raw material. In some examples, inventory items 302 can include other packaged or wrapped (e.g., storage wrapped) items. In some examples, inventory items 302 can include bins or totes that store a manufactured good or raw material. In other examples, inventory items 302 may not be packaged in any box, wrapping or storage material. In some examples, inventory items 302 include an identifier (e.g., barcode).

Inventory items 302 can be stored directly on an inventory shelving unit 301 or on pallets. For example, inventory items 302 may be tightly coupled with other similar items and stored on an inventory pallet for easy storage and retrieval. In some examples, inventory pallets may be stored on inventory shelving units 301. In other examples, inventory pallets may be stored on the floor of the warehouse environment 300. For instance, inventory pallets that are stored on the warehouse floor may be identified as an obstacle for an autonomous drone 100. In some examples, inventory pallets stored on the warehouse floor may be captured in a warehouse dimensional layout. FIG. 11A illustrates an example of inventory pallets stored on the warehouse floor.

In the example warehouse environment 300, inventory shelving units 301 can support landing pads 200. In some examples, the landing pads 200 can be affixed to an end of the inventory shelving unit 301. For example, landing pads 200 affixed to an end of the inventory shelving unit 301 allow for more takeoff and landing space for an autonomous drone 100. In some examples, the landing pad 200 is affixed towards the top level of the inventory shelving unit 301. For example, affixing the landing pad 200 towards the top level of the inventory shelving unit 301 can ensure that people or warehouse machinery do not collide with the autonomous drone 100 or landing pad 200.

The example autonomous drone 100 can execute a flight plan 303 to navigate the warehouse environment 300. For example, when an autonomous drone 100 receives mission data 116, the autonomous drone 100 can determine a flight plan 303 to execute the inventory mission. In some examples, a flight plan 303 can be determined based on the mission data 116. In some examples, the flight plan 303 can be generated by the autonomous drone 100. In other examples, the flight plan 303 can be generated remotely. In some examples, the flight plan 303 can be transmitted from the landing pad 200.

The flight plan 303 can be updated as the autonomous drone 100 flies throughout the warehouse environment 300. For example, the autonomous drone 100 can encounter an obstacle as it executes its inventory mission. In some examples, the autonomous drone 100 can execute active avoidance to avoid the obstacle. Active avoidance can include avoidance maneuvers executed by the autonomous drone 100 to avoid obstacles. In some examples, active avoidance can prevent the autonomous drone 100 from colliding with an object in the warehouse environment 300. In some examples, the autonomous drone 100 can generate an updated flight plan 303 to complete its inventory mission following the avoidance of an obstacle. In some examples, a flight plan 303 can account for known obstacles in the warehouse environment 300.

The flight plan 303 can optimize the travel time and distance for an autonomous drone 100. For instance, the autonomous drone 100 can utilize the flight planning system 109 to generate the most efficient flight plan 303 for the autonomous drone 100 to execute its inventory mission. In some examples, the autonomous drone 100 can utilize sensor data 115 perceived by the autonomous drone 100 to determine the most efficient flight plan 303. In some examples, the autonomous drone 100 can utilize mission data 116 to determine the most efficient flight plan 303. In other examples, the autonomous drone 100 can utilize both sensor data 115 and mission data 116 to generate and optimize the flight plan 303.

As further described herein, the autonomous drone 100 can traverse the warehouse environment 300 to scan inventory items 302 stored on inventory shelving units 301 by executing a flight plan 303 and docking on a landing pad 200. In some examples, multiple autonomous drones 100 can traverse the warehouse environment 300 by executing respective flight plans 303 simultaneously.

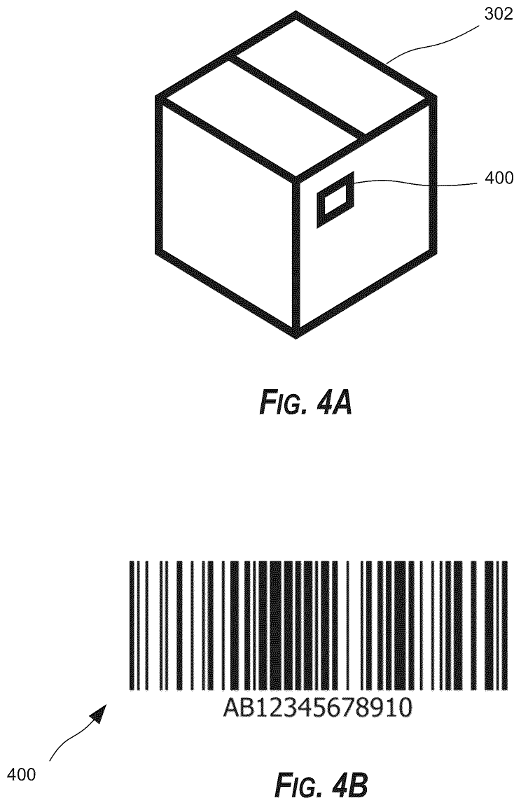

FIG. 4A is a representation of an example inventory item, according to some implementations of the present disclosure. An inventory item 302 can be any manufactured product or raw material which is being stored in the warehouse environment 300. For example, inventory items 302 can include boxes which contain a manufactured good or raw material. In some examples, inventory items 302 can include other packaged or wrapped (e.g., storage wrapped) items. In some examples inventory items 302 can include bins or totes that store a manufactured good or raw material. In other examples, inventory items 302 may not be packaged in any box, wrapping or storage material. In some examples, inventory items 302 include an inventory barcode 400.

FIG. 4B is a representation of an example identifier such as an inventory barcode, according to some implementations of the present disclosure. An inventory barcode 400 can include any type of linear bar code or two dimensional matrix bar code. In some examples, an inventory barcode 400 can include a QR (Quick Response) code. For instance, an inventory barcode 400 can include a QR Code model 1 or model 2, Micro QR Code, iQR Code. SQRC Code, FrameQR, HCC2D Code etc. In some examples, inventory bar codes can include RFID (Radio-frequency identification) tags. For instance, the autonomous drone 100, can utilize the sensor suite 101 to obtain sensor data 115 that includes radio frequencies to automatically identify, and track RFID tags attached to the inventory item 302. The RFID tags can include passive tags or active tags and become identifiable by emitting low, high, or ultrahigh frequencies. An inventory barcode 400 can include any means which identifies an inventory item within a warehouse environment 300 including, but not limited to handwritten or printed text readable by cameras or OCR (optical character recognition), NFC (near field communication), etc. FIG. 11B illustrates an example inventory barcode 400 on an inventory item 302.

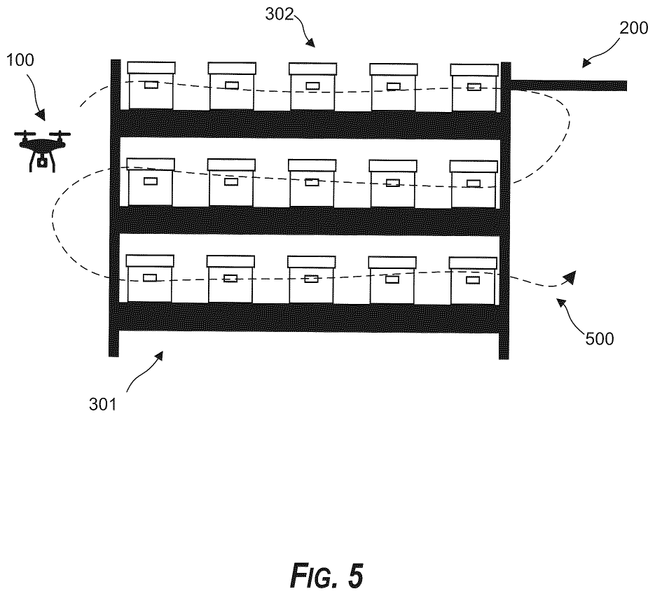

FIG. 5 is a representation of an example autonomous drone flight plan to scan inventory, according to some implementations of the present disclosure. As further described herein, an autonomous drone 100 can scan inventory barcodes 400 located on inventory items 302 that are stored on inventory shelving units 301. In some examples, the autonomous drone 100 can execute an inventory scanning flight plan 500 to scan the inventory barcodes 400 located on the inventory items 302 on each level of an inventory shelving unit 301.

In some examples, the inventory scanning flight plan 500 can be generated by a flight planning system 109 of the autonomous drone 100. In some examples, the inventory scanning flight plan 500 can be indicative of mission data 116 which includes inventory items 302 to be scanned by the autonomous drone 100. In some examples, the inventory scanning flight plan 500 can be generated by utilizing sensor data 115 captured by the sensor suite 101 of the autonomous drone 100 to identify the correct inventory shelving unit 301 that is storing the inventory items 302 and navigating to a correct shelf level of the inventory shelving unit 301 where the autonomous drone 100 can scan a bar code 400 on the inventory item 302.

In some examples, the inventory scanning flight plan 500 can direct the autonomous drone 100 to fly at a consistent altitude (e.g., within 24 inches from the barcode) while scanning inventory barcodes 400 on inventory items 302 located on the same shelf. For example, the autonomous drone 100 can fly at a consistent altitude of 8 feet above the warehouse environment floor to scan inventory barcodes 400 on inventory items 302 located on the top shelf of an inventory shelving unit 301. In some examples, the autonomous drone 100 can fly at a lower altitude such as 5 feet above the warehouse environment floor to scan inventory barcodes 400 on inventory items 302 located on a lower shelf on the inventory shelving unit 301. The autonomous drone 100 can utilize the cameras 106 of the sensor suite 101 to determine the altitude of the autonomous drone 100. For example, the autonomous drone 100 may include a downward facing camera 106 that measures to height of the autonomous drone from the nearest surface.

The autonomous drone 100 can execute the inventory scanning flight plan 500 by utilizing its subsystems. For example, the autonomous drone 100 can obtain sensor data 115 that indicates the autonomous drone 100 located a target inventory shelving unit 301. In some examples the cameras 106 of the sensor suite 101 can utilize a camera 106 to capture wide view images of the inventory shelving unit 301. In some examples, the cameras 106 of the sensor suite 101 can utilize a narrow view image to locate inventory barcodes 400 which need to be scanned by the autonomous drone 100. In some examples, wide view images can be utilized to scan inventory barcodes 400 by analyzing multiple barcodes included in the wide view image. In some examples, the autonomous drone 100 can utilize the indoor positioning sensors 103, graphics processors 102, optical sensors 104, additional sensors 105, and cameras 106 to execute the inventory scanning flight plan 500.

In some examples, the inventory scanning flight plan 500 can include navigating past location identifiers. For example, as the autonomous drone 100 executes an inventory scanning flight plan 500, the autonomous drone 100 can perceive a landing pad 200. In some examples, the landing pad 200 can include visual identifiers which provide location data to the autonomous drone 100. In some examples, the autonomous drone 100 can determine a correct inventory shelving unit 301 by perceiving a landing pad 200. In some examples, the autonomous drone 100 can dock on a landing pad 200 after executing an inventory scanning flight plan 500.

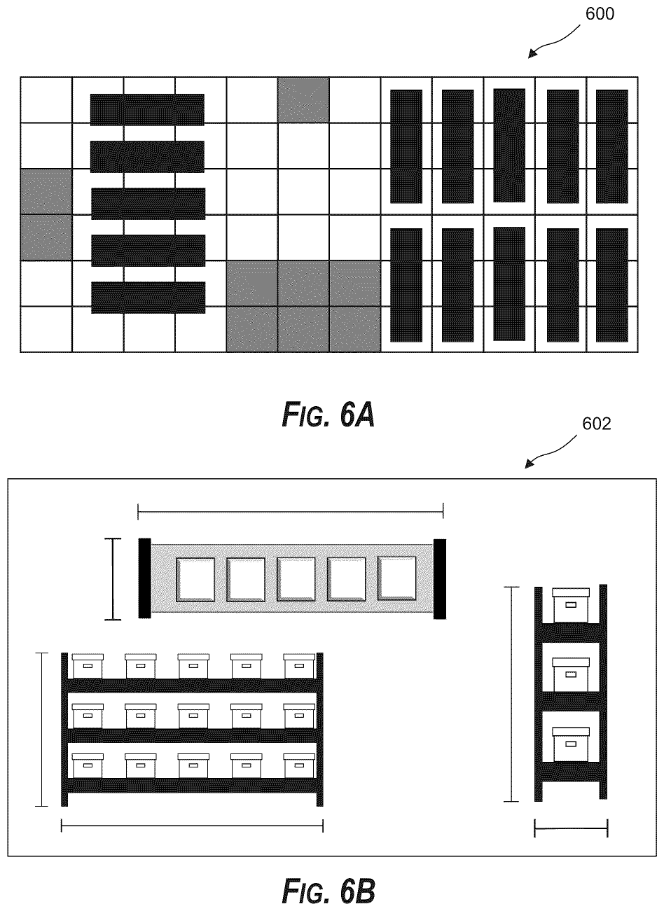

FIG. 6A is a representation of an example dimensional layout of a warehouse environment, according to some implementations of the present disclosure. In some examples, the dimensional layout 600 can include a dimensional mapping of the warehouse environment 300. For example, the dimensional layout 600 can be a 2D, 3D, or 4D mapping of the warehouse environment 300 which includes the dimensions of the warehouse environment 300 itself, dimension of warehouse infrastructure (e.g., inventory shelving units 301), locations of warehouse infrastructure, and positional information such as entry ways or exits.

In some examples, the dimensional layout 600 can include positional points which indicate positions within the warehouse environment 300. For example, a dimensional layout 600 can include inventory shelving units 301 which indicate inventory shelving units 301 in the warehouse environment 300. In some examples, the dimensional layout 600 can include entry ways or exits which indicate entry ways or exits in the warehouse environment 300. In other examples, warehouse equipment or machinery can be indicated on a dimensional layout 600 which indicate warehouse equipment or machinery in the warehouse environment 300.

In some examples, the dimensional layout 600 can be included in mission data 116 which is transmitted from a landing pad 200. In some examples, the dimensional layout 600 can be stored on the autonomous drone 100. In other examples, the dimensional layout 600 can be updated by the autonomous drone 100 and transmitted to the landing pad 200. In some examples, the dimensional layout 600 can be updated manually when the layout of the warehouse environment 300 changes. For example, if an inventory shelving unit 301 unit is added or moved within the warehouse environment 300, the dimensional layout 600 can be updated to reflect the change.

The dimensional layout 600 can be generated manually or automatically. In some examples, the dimensional 600 can be generated by manually mapping the layout of the warehouse environment 300 using LiDAR and camera sensors. In some examples, the dimensional layout 600 can be generated by manually flying a drone throughout the warehouse environment 300. In some examples, the dimensional layout 600 can be generated by processing a facility map of the warehouse environment 300 which includes dimensional measurements of the warehouse environment 300 and warehouse infrastructure (e.g., inventory shelving units 301).

FIG. 6B is a representation of example dimensions of an inventory shelving unit, according to some implementations of the present disclosure. In some examples, the inventory shelving unit dimensions 602 can be included on the dimensional layout 600 of the warehouse environment 300. In some examples, the inventory shelving unit dimensions 602 can be consistent among all inventory shelving units 301 throughout the warehouse environment 300. In some examples, the inventory shelving unit dimensions 602 can vary across the inventory shelving units 301 located in the warehouse environment 300.

Inventory shelving unit dimensions 602 can include all spatial dimensions of an inventory shelving unit 301. For example, inventory shelving unit dimensions 602 can include length, width, height, and depth. In some examples, the inventory shelving unit dimensions 602 can include specific measurements of each component (e.g., inventory shelving unit beam) of an inventory shelving unit 301. In other examples, the inventory shelving unit dimensions 602 can include general measurements of inventory shelving units 301.

The inventory shelving unit dimensions 602 can be used by the autonomous drone 100 to perform object detection. For example, sensor data 115 obtained by the autonomous drone 100 can be processed by the autonomy system 107 to determine that an object in the surrounding environment of the autonomous drone 100 is an inventory shelving unit 301 based on the inventory shelving unit dimensions 602. In some examples, the autonomy system 107 can be trained to detect inventory shelving units 301 based on the inventory shelving unit dimensions 602. In other examples, the autonomy system can determine a specific inventory shelving unit 301, by determining that the inventory shelving unit dimensions 602 match the dimensions of an object on the dimensional layout 600 of the warehouse environment 300.

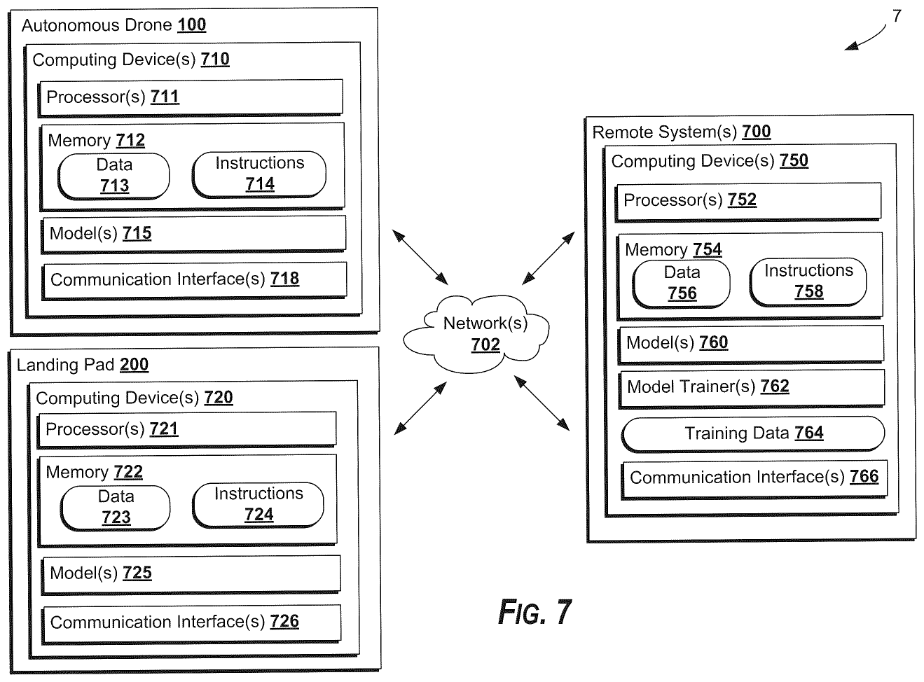

FIG. 7 is a block diagram of an example computing ecosystem 7, according to some implementations of the present disclosure. The example computing ecosystem 7 can include an autonomous drone 100 and a landing pad 200 that are communicatively coupled over one or more networks 702. In some implementations, the autonomous drone 100 and the landing pad 200 can communicate through a contact connection (e.g., wired ethernet connection) when the autonomous drone 100 is docked on the landing pad 200. In other implementations, the autonomous drone 100 and the landing pad 200 can communicate over a wireless connection (e.g., wireless local area network (WLAN), wireless wide area network (WWAN), near-field communication, other shorter distance communication protocols, etc.) while the autonomous drone 100 is in-flight. In some implementations, the autonomous drone 100 or the landing pad 200 can implement one or more of the systems, operations, or functionalities described herein for validating one or more systems or operational systems.

In some implementations, a remote system 700, the autonomous drone 100, and/or the landing pad 200 can be communicatively coupled over one or more networks 702. The remote system 700 can be, for example, a cloud-based server system that is remote from the autonomous drone 100 and the landing pad 200. This may include, for example, a computing system associated with a warehouse, an entity associated with the inventory (e.g., shipper, manager, operator), an entity associated with the autonomous drone 100 (e.g., manufacturer, distributor, operator, maintainer), an entity associated with the landing pad 200 (e.g., manufacturer, distributor, operator, maintainer), etc. In some implementations, one or more of the networks 702 used to communicate with the remote system 700 may be different than one or more of the networks 702 used by the autonomous drone 100 and the landing pad 200 to communicate with one another.

In some implementations, the computing devices 710 can be included in an autonomous drone 100 and be utilized to perform the functions of an autonomous drone 100 as described herein. For example, the computing devices 710 can be located onboard an autonomous drone 100 and implement the autonomy system 107 for autonomously operating the autonomous drone 100. In some implementations, the computing devices 710 can represent the entire onboard computing system or a portion thereof (e.g., the drone localization system 108, the flight planning system 109, the drone control system 110, or a combination thereof, etc.). In other implementations, the computing devices 710 may not be located onboard an autonomous drone 100. In some implementations, the autonomous drone 100 can include one or more distinct physical computing devices 710.

The autonomous drone 100 (e.g., the computing device(s) 710 thereof) can include one or more processors 711 and a memory 712. The one or more processors 711 can be any suitable processing device (e.g., a processor core, a microprocessor, an ASIC, a FPGA, a controller, a microcontroller, etc.) and can be one processor or a plurality of processors that are operatively connected. The memory 712 can include one or more non-transitory computer-readable storage media, such as RAM, ROM, EEPROM, EPROM, one or more memory devices, flash memory devices, etc., and combinations thereof.

The memory 712 can store information that can be accessed by the one or more processors 711. For instance, the memory 712 (e.g., one or more non-transitory computer-readable storage media, memory devices, etc.) can store data 713 that can be obtained (e.g., received, accessed, written, manipulated, created, generated, stored, pulled, downloaded, etc.). The data 713 can include, for instance, sensor data 115, mission data 116, data associated with autonomy functions (e.g., data associated with the perception, planning, or control functions), simulation data, or any data or information described herein. In some implementations, the autonomous drone 100 can obtain data from one or more memory device(s) that are remote from the autonomous drone 100.

The memory 712 can store computer-readable instructions 714 that can be executed by the one or more processors 711. The instructions 714 can be software written in any suitable programming language or can be implemented in hardware. Additionally, or alternatively, the instructions 714 can be executed in logically or virtually separate threads on the processor(s) 711.

For example, the memory 712 can store instructions 714 that are executable by one or more processors (e.g., by the one or more processors 711, by one or more other processors, etc.) to perform (e.g., with the computing device(s) 710, the autonomous drone 100, or other system(s) having processors executing the instructions) any of the operations, functions, or methods/processes (or portions thereof) described herein.

In some implementations, the autonomous drone 100 can store or include one or more models 715. In some implementations, the models 715 can be or can otherwise include one or more machine-learned models (e.g., a machine-learned operational system, etc.). As examples, the models 715 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the autonomous drone 100 can include one or more models for implementing subsystems of the autonomy system(s) 107, including any of: the drone localization system 108, the flight planning system 109, or the drone control system 110.

In some implementations, the autonomous drone 100 can obtain the one or more models 715 using communication interface(s) 718 to communicate with the landing pad 200 over the network(s) 702. For instance, the autonomous drone 100 can store the model(s) 715 (e.g., one or more machine-learned models) in the memory 712. The autonomous drone 100 can then use or otherwise implement the models 715 (e.g., by the processors 711). By way of example, the autonomous drone 100 can implement the model(s) 715 to localize an autonomous drone 100 in the warehouse environment 300, perceive an autonomous drone's 100 environment or objects therein, plan one or more future states of an autonomous drone 100 for moving through a warehouse environment 300, control an autonomous drone 100 for interacting with a warehouse environment 300, etc.

The landing pad 200 can include one or more computing devices 720. The landing pad 200 can include one or more processors 721 and a memory 722. The one or more processors 721 can be any suitable processing device (e.g., a processor core, a microprocessor, an ASIC, a FPGA, a controller, a microcontroller, etc.) and can be one processor or a plurality of processors that are operatively connected. The memory 722 can include one or more non-transitory computer-readable storage media, such as RAM, ROM, EEPROM, EPROM, one or more memory devices, flash memory devices, etc., and combinations thereof.

The memory 722 can store information that can be accessed by the one or more processors 721. For instance, the memory 722 (e.g., one or more non-transitory computer-readable storage media, memory devices, etc.) can store data 723 that can be obtained. The data 723 can include, for instance, sensor data 115, mission data 116, data associated with a warehouse environment inventory management system, data associated with inventory scanning missions, or any data or information described herein. In some implementations, the landing pad 200 can obtain data from one or more memory device(s) that are remote from the landing pad.

For example, the memory 722 can store instructions 724 that are executable (e.g., by the one or more processors 721, by one or more other processors, etc.) to perform (e.g., with the computing device(s) 720, the landing pad 200, or other system(s) having processors for executing the instructions, such as computing device(s) 710 or the autonomous drone 100) any of the operations, functions, or methods/processes described herein. This can also include, for example, validating a machined-learned operational system.

In some implementations, the landing pad 200 can include one or more server computing devices. In the event that the landing pad 200 includes multiple server computing devices, such server computing devices can operate according to various computing architectures, including, for example, sequential computing architectures, parallel computing architectures, or some combination thereof.

The autonomous drone 100 and the landing pad 200 can each include communication interfaces 718 and 726, respectively. The communication interfaces 718 and 726 can be used to communicate with each other or one or more other systems or devices, including systems or devices that are remotely located from the autonomous drone 100 or the landing pad 200. The communication interfaces 718 and 726 can include any circuits, components, software, etc. for communicating with one or more networks (e.g., the network(s) 702). In some implementations, the communication interfaces 718 and 726 can include, for example, one or more of a communications controller, receiver, transceiver, transmitter, port, conductors, software or hardware for communicating data.

In some examples, the communication interfaces 718 and 726 of the autonomous drone 100 and landing pad 200 can communicate through physical contact or wired connection while the autonomous drone 100 is docked on the landing pad 200. For example, the communication interface 726 can include a mechanism (e.g., data pins) to transfer data to the communication interface 718. In some examples, when the autonomous drone 100 makes contact with the landing pad 200 (e.g., data pins) a high-speed telecommunication channel can be established to allow for communication between the autonomous drone 100 and the landing pad 200.

In some examples, the communication interfaces 718 and 726 of the autonomous drone 100 and landing pad 200 can communicate wirelessly as the autonomous drone 100 flies throughout the warehouse environment. For example, the communication interface 726 can emit a wireless signal (e.g., wireless local area network (WLAN)) which can be received by the communication interface 718 of the autonomous drone 100 as the autonomous drone 100 flies throughout the warehouse environment. In some examples, a connection can be established between the communication interfaces 718 and 726 when the signal strength emitted from communication interface 726 reaches a certain threshold. In some examples, the communication interface 726 can include a pool of internet protocol (IP) addresses that are dynamically assigned to the communication interface 718 of an autonomous drone 100 in range of the wireless signal.

The communication interfaces 718 and 726 can transition between contact (e.g., wired) communication and wireless communication. For example, when an autonomous drone 100 takes off to execute an inventory scanning mission, the communication interface 726 of landing pads 200 can beacon (e.g., regular transmissions to inform devices about available access points) via communication interfaces 718 of autonomous drones 100. In some examples, the communication interfaces 726 of the autonomous drone 100 can beacon every 5 seconds to detect an autonomous drone 100 in range of the emitted signal. In some examples, the communication interfaces 718 and 726 can automatically activate a contact (e.g., wired) connection when the autonomous drone 100 docks on a landing pad 200. In some examples, the contact connection can generate an ethernet connection.

In some examples, the communication interfaces 718 and 726 can maintain a constant connection. For example, a warehouse environment 300 can include multiple landing pads 200 located throughout the warehouse environment 300. When an autonomous drone 100 flies throughout the warehouse environment 300, the wireless signal emitted from a first communication interface 726 of a first landing pad 200 may decrease while the wireless signal emitted from a second communication interface 726 of a landing pad 200 may increase. In some examples, the communication interfaces 718 and 726 may maintain a constant connection by seamlessly switching between different landing pads 200 as it flies throughout the warehouse environment 300. In some examples, the communication interfaces 718 and 726 can maintain a connection when the autonomous drone 100 docks on a landing pad 200 and activates a contact (e.g., wired) connection.

The remote system 700 can include one or more computing devices 750. The remote system 700 can include one or more processors 752 and a memory 754. The one or more processors 752 can be any suitable processing device (e.g., a processor core, a microprocessor, an ASIC, a FPGA, a controller, a microcontroller, etc.) and can be one processor or a plurality of processors that are operatively connected. The memory 754 can include one or more non-transitory computer-readable storage media, such as RAM, ROM, EEPROM, EPROM, one or more memory devices, flash memory devices, etc., and combinations thereof.

The memory 754 can store information that can be accessed by the one or more processors 752. For instance, the memory 754 (e.g., one or more non-transitory computer-readable storage media, memory devices, etc.) can store data 756 that can be obtained. The data 756 can include, for instance, any data or information described herein. In some implementations, the remote system 700 can obtain data from one or more memory device(s) that are remote from the remote system 700.

For example, the memory 754 can store instructions 758 that are executable (e.g., by the one or more processors 752, by one or more other processors, etc.) to perform (e.g., with the computing device(s) 750, the remote system 700, or other system(s) having processors for executing the instructions) any of the operations, functions, or methods/processes described herein.

In some implementations, the remote system 700 includes or is otherwise implemented by one or more server computing devices. In instances in which the remote system 700 includes plural server computing devices, such server computing devices can operate according to sequential computing architectures, parallel computing architectures, or some combination thereof.

As described above, the remote system 700 can store or otherwise include one or more models 760. For example, the models 760 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The other systems of ecosystem 7 can train the models 715 and/or 760 via interaction with the remote system 700 that is communicatively coupled over the networks 702. The remote system 700 can be separate from the landing pad 200 or can be a portion of the landing pad 200.

The remote system 700 can include a model trainer 762 that trains the machine-learned models 715 and/or 760 stored at another computing system and/or the remote system 700 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 762 can perform a number of generalization techniques (e.g., weight decays, dropouts, etc.) to improve the generalization capability of the models being trained.

In particular, the model trainer 762 can train the models 715 and/or 760 based on a set of training data 764. The training data 764 can include, for example, labelled training data including one or more labelled features.

The model trainer 762 includes computer logic utilized to provide desired functionality. The model trainer 762 can be implemented in hardware, firmware, and/or software controlling a general purpose processor. For example, in some implementations, the model trainer 762 includes program files stored on a storage device, loaded into a memory and executed by one or more processors. In other implementations, the model trainer 762 includes one or more sets of computer-executable instructions that are stored in a tangible computer-readable storage medium such as RAM, hard disk, or optical or magnetic media.

The network(s) 702 can be any type of network or combination of networks that allows for communication between devices. In some implementations, the network(s) can include one or more of a local area network, wide area network, the Internet, secure network, cellular network, mesh network, peer-to-peer communication link or some combination thereof and can include any number of wired or wireless links. Communication over the network(s) 702 can be accomplished, for instance, through a network interface using any type of protocol, protection scheme, encoding, format, packaging, etc.

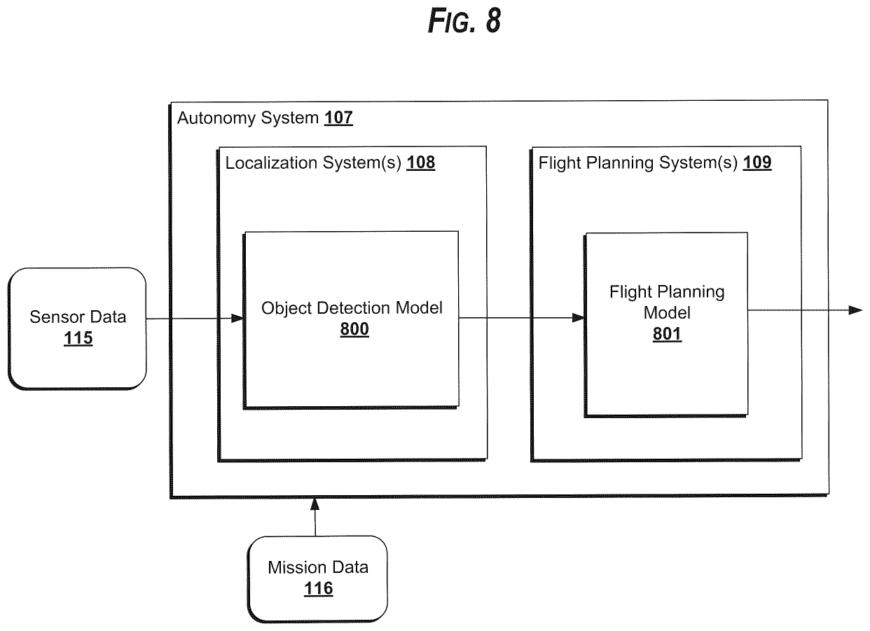

FIG. 8 is a block diagram of an example computing system for localizing and flight planning of the autonomous drone 100, according to some implementations of the present disclosure. The localization system 108 and flight planning system 109 can be included, for example, within the autonomy system 107 of the autonomous drone 100. Although FIG. 8 illustrates an example implementation of a localization system 108 and flight planning system 109 having various components, it is to be understood that the components can be rearranged, combined, omitted, etc. within the scope of and consistent with the present disclosure.

The localization system 108 can include a trained object detection model 800. The object detection model 800 can include one or more machine-learned models trained to detect objects in the warehouse environment 300. The object detection model 800 can be or otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The object detection model 800 can be trained through the use of one or more model trainers and training data. The model trainers can be trained using one or more training or learning algorithms. One example training technique is backwards propagation of errors. In some examples, simulations can be implemented for obtaining the training data or for implementing the model trainer(s) for training or testing the model(s). In some examples, the model trainer(s) can perform supervised training techniques using labeled training data. As further described herein, the training data can include labelled image frames that have labels indicating a type of object and location of an object. In some examples, the training data can include simulated training data (e.g., training data obtained from simulated scenarios, inputs, configurations, warehouse environments, etc.).

Additionally, or alternatively, the model trainer(s) can perform unsupervised training techniques using unlabeled training data. By way of example, the model trainer(s) can train one or more components of a machine-learned model to perform object detection through unsupervised training techniques using an objective function (e.g., costs, rewards, heuristics, constraints, etc.). In some implementations, the model trainer(s) can perform a number of generalization techniques to improve the generalization capability of the model(s) being trained. Generalization techniques include weight decays, dropouts, or other techniques.

The object detection model 801 can obtain sensor data 115 from the sensor suite 101. In some examples, the object detection model 801 can be trained to detect an object and determine its location by analyzing the sensor data 115. An example of the object detection model 800 analyzing sensor data 115 to identify an object in the warehouse environment 300 and determine its location is shown in FIG. 9.

The object detection model 800 can perform discrete-continuous object tracking. For example, the object detection model 800 can continuously track the location and movement of an object in the surrounding warehouse environment 300 of the autonomous drone 100. For instance, the object detection model 800 can individually detect an object in each image (e.g., using computer vision techniques). In some examples, the object detection model 800 can determine an object is stationary based on detecting the object in a constant position in each image frame across a plurality of image frames. In some examples, the object detect model can determine an objection is in motion based on detecting the object in multiple positions across a plurality of image frames. In some examples, the location of objects can be tracked in cases where image frames have low lighting or appearance variations based on object detections in previous or subsequent image frames. In other examples, the object detection model 800 can string together multiple image frames to perform discrete-continuous object tracking.

In some examples, the object detection model 800 can utilize mission data 116 to perform object detection of objects in the warehouse environment 300. In some examples, the object detection model 800 can obtain mission data 116 indicative of one or more inventory items 302 to be scanned by an autonomous drone 100. In some examples, object detection model 800 can obtain sensor data 115 indicative of an object of interest within a warehouse environment 300 of the autonomous drone 100. An example of the object detection model 800 utilizing mission data 116 to perform object detection is shown in FIG. 9.

In some examples, the autonomy system 107 can localize the autonomous drone 100 based on detecting objects in the surrounding warehouse environment 300. For example, the localization system 108 can determine the location of the autonomous drone 100 based on identifying and determining the location of objects in the surrounding environment warehouse environment 300. In some examples, the localization system 108 of the autonomous drone 100 can pinpoint its exact location (e.g., within a percent confidence, error, etc.) within the warehouse environment 300 based on determining the location of an object in the immediate vicinity of the autonomous drone 100. In some examples, the localization system 108 can determine the location of the autonomous drone 100 by comparing the distance of the autonomous drone 100 from an object identified in the surrounding warehouse environment 300. An example of the autonomous drone 100 localizing based on identifying and determining the location of an object is shown in FIG. 9

The object detection model 800 can identify objects in the surrounding environment of the autonomous drone 100 and determine a location for the objects. For instance, the object detection model 800 can detect an object based on the features or characteristics of the pixels within a camera image frame. The object detection model 800 can determine their location within the environment based on matching the objects to other features in the images and/or map data 203. The object detection model 800 can provide the object detection data (e.g., indicative of the object locations) to the flight planning system 109 as input data to generate flight plans 303 for the autonomous drone 100.

The flight planning system 109 can include a trained flight planning model 801 which can be configured to determine how the autonomous drone 100 is to interact and traverse the warehouse environment 300. The flight planning model 801 can include one or more machine-learned models trained to determine one or more flight plans 303 for an autonomous drone 100. The flight planning model 801 can be or otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The flight planning model 801 can be trained through the use of one or more model trainers and training data. The model trainers can be trained using one or more training or learning algorithms. One example training technique is backwards propagation of errors. In some examples, simulations can be implemented for obtaining the training data or for implementing the model trainer(s) for training or testing the model(s). In some examples, the model trainer(s) can perform supervised training techniques simulated training data. As further described herein, the training data can include a real-world warehouse environment 300 or a simulated warehouse environment 300. In some examples, the simulated training data can include training data obtained from simulated scenarios, inputs, configurations, mock warehouse environments, etc.).

The flight planning model 801 can determine one or more flight plans for an autonomous drone 100. A flight plan 303 can include one or more trajectories (e.g., flight trajectories) that indicate a path for the autonomous drone 100 to follow. A trajectory can be of a certain length or time range. The length or time range can be defined by the computational planning horizon of the flight planning system 109. A trajectory can be defined by one or more waypoints (with associated coordinates). The way points(s) can be future locations(s) for the autonomous drone 100. The flight plans 303 can be continuously generated, updated, and considered by the autonomy system 107.

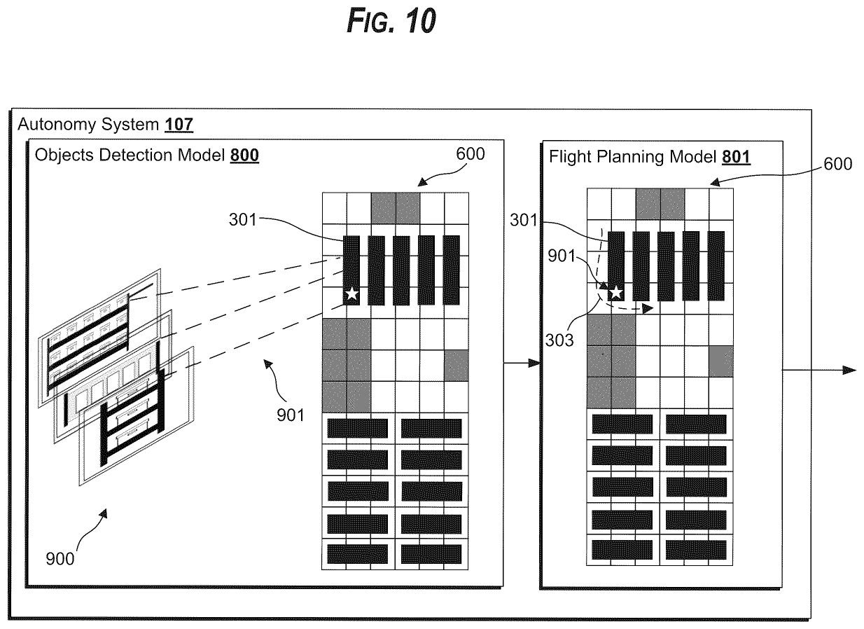

The flight planning model 801 can receive as input, object detection data to generate flight plans 303 for the autonomous drone 100. An example of the flight planning model 800 generating a flight plan 303 based on object detection data is shown in FIG. 10.

In some examples, mission data 116 can be received as input to the flight planning model 801. For example, mission data 116 can include map data 201, location data 202, and inventory data 203 that can be used to generate a flight plan 303. For instance, the flight planning model 801 can utilize the location of inventory data 203 to generate a flight plan 303 including a trajectory that will lead the autonomous drone 100 to the location of the inventory items 302. The trajectory can be developed such that the waypoints can avoid interference with any detected objects or objects (e.g., warehouse infrastructure) encoded in the map data 203. The trajectory can be encoded with speed, altitude, acceleration, yaw, or other operational parameters for traveling in accordance with the waypoints and avoiding objects within the warehouse environment 300 while travelling to a destination location.

In some examples, the flight planning model 801 can utilize mission data 116 to determine an updated flight plan 303. For example, if mission data 116 indicates that an inventory item 302 is to be located at a specific location and the autonomous drone 100 is unable to locate the inventory item 302 at the specific location, the flight planning model 801 can generate an updated flight plan 303 to rescan the missed inventory items 302. In some examples, the flight planning model 801 can generate a new flight plan 303 to avoid an obstacle which increases travel distance for the autonomous drone 100. In other examples, the flight planning model 801 can generate modified flight plans to locate misslotted inventory items 302.

The object detection model 800 and the flight planning model 801 can both utilize the sensor data 115 and mission data 116 to detect objects in the surrounding warehouse environment 300 to localize an autonomous drone 100 and generate a flight plan 303 to traverse the warehouse environment 300.

FIG. 9 is a block diagram of an example computing system for localizing an autonomous drone, according to some implementations of the present disclosure. In FIG. 9 at a time after the sensor suite 101 has captured sensor data 115, the sensor data 115 can be processed by an object detection model 800 to determine whether the object depicted in the image frame 903 is an object of interest 900, determine the location of the object of interest 900, and generate a location anchor 901 for the object of interest 900 to localize the autonomous drone 100.

For instance, the object detection model 800 can obtain image frames 903 depicting portions of the surrounding warehouse environment 300 of the autonomous drone 100 including an inventory shelving unit 301. The object detection model 800 can obtain object characteristics by projecting a bounding shape 902 on to the image frames 903.

The bounding shape 902 can be any shape (e.g., a polygon) that includes an inventory shelving unit 301 depicted in a respective image frame. For example, as shown in FIG. 9, the bounding shape 902 can include a square that encapsulates the inventory shelving unit 301 (e.g., a bounding box). One of ordinary skill in the art will understand that other shapes can be used such as circles, rectangles, etc. In some implementations, the bounding shape 902 can include a shape that matches the outermost boundaries/perimeter of the inventory shelving unit 301 and the contours of those boundaries. The bounding shape can be generated on a per pixel level. The object characteristics can include the x, y, z coordinates of the bounding shape center, the length, width, and height of the bounding shape, etc.

The object detection model 800 can generate data (e.g., labels) that correspond to the object characteristics of the bounding shape 902. Labels can include the type of object (e.g., inventory shelving unit 301, inventory item 302, obstacle, etc.), location of the object, orientation of the object (e.g., stationary or moving object), etc. In some examples, the labels that correspond to the bounding shape 902 can include a location of the inventory shelving unit 301 encapsulated in the bounding shape 902. In some examples, the object detection model 800 can determine the location of the inventory shelving unit 301 and generate a location label. The location label can be coordinates or a position on a dimensional layout 600 of the warehouse environment 300. The location label can be a location relative to another object in the warehouse environment 300. The location label can be a location relative to a known location such as an exit or entry way. The location label can be any data that indicates a location or position on a dimensional layout 600 in or in the warehouse environment 300.

The object detection model 800 can be trained to detect an inventory shelving unit 301 and determine its location based on the labelled training data that includes similar labels to those described above.

In some examples, the object detection model 800 may not need to subsequently determine the location of an inventory shelving unit 301 once the object detection model 800 has generated a location label. For example, an image frame 903 containing an inventory shelving unit 301 which includes previously generated labels will not need to generate another location label. In some examples, location labels can used by other autonomous drones 100 to identify an inventory shelving unit 301 in a respective image frame 903 and determine a location of the inventory shelving unit 301.

In some examples, the object detection model 800 can obtain a time at which the respective image frames 903 were captured by the sensor suite 101. In some examples, the time at which the respective image frames 903 were captured can be used to compare image frames 903 with previously captured image frames. In other examples, the object detection model 800 can determine an inventory shelving unit 301 has already been identified and labeled based on the time in which the image frames 903 were captured.

The object detection model 800 can utilize a dimensional layout 600 of the warehouse environment 300 to identify an inventory shelving unit 301. For example, the object detection model 800 can determine the physical characteristics (e.g., height, width, length, etc.) of the inventory shelving unit 301 encapsulated in the bounding shape 902 and determine the physical characteristics of the inventory shelving unit 301 match the dimensions of a specific inventory shelving unit 301 on the dimensional layout 600. In some examples, the object detection model 800 can generate a label indicating the object is an inventory shelving unit 301 based on the matching characteristics.

In some examples, the object detection model 800 can determine the physical characteristics of inventory shelving unit 301 from the bounding shape 902 are within a predetermined threshold which correlate to the dimensions of an inventory shelving unit 301 on the dimensional layout 600. In other examples, the object detection model 800 can determine the physical characteristics of the inventory shelving unit 301 within the bounding shape 902 have relative dimensions to an inventory shelving unit 301 on the dimensional layout 600. In some examples, the object detection model 800 can generate a label indicating the object is an inventory shelving unit 301 based on exact, threshold, or relative physical characteristics to an inventory shelving unit 301 on a dimensional layout 600.

In some examples, the object detection model 800 can determine that objects that do not possess relative physical characteristics, match, or fall within a threshold of physical characteristics of objects on a dimensional layout 600 can be filtered out of the downstream analysis. In some examples, the object detection model 800 can determine that objects that do not possess relative physical characteristics, match, or fall within a threshold of physical characteristics of objects on a dimensional layout 600 can be analyzed to determine whether the object is an obstacle.

In some examples, the object detection model 800 can generate location labels indicating the location of the inventory shelving unit 301 by associating the inventory shelving unit 301 depicted in the image frames 903 with an inventory shelving unit 301 on the dimensional layout 600. For instance, once the object detection model 800 has determined the inventory shelving unit 301 depicted in the image frames 903 is associated with an inventory shelving unit 301 on the dimensional layout 600, the object detection model 800 can generate a location label which associates the inventory shelving unit 301 depicted in the image frames 903 with the inventory shelving unit 301 on the dimensional layout 600. The inventory shelving unit 301 on the dimensional layout 600 can include a position or location which represents the location label of the inventory shelving unit 301 depicted in the image frames 903.

In some examples, the object detection model 800 can determine a location of inventory shelving unit 301 by determining the image frame 903 includes other location identifiers. For example, a dimensional layout 600 of the warehouse environment 300 can include exits and entry ways within the warehouse environment 300. The object detection model 800 can determine a inventory shelving unit 301 is located on a specific position on the dimensional layout 600 by determining that the image frames 903 includes an inventory shelving unit 301 adjacent to the exit or entry way and determine the inventory shelving unit 301 depicted in the bounding shape 902 is the specific inventory shelving unit 301 adjacent to an exit or entry way by associating the inventory shelving unit 301 with an inventory shelving unit 301 on the dimensional layout 600.

In some examples, the object detection model 800 can determine a location of the inventory shelving unit 301 by using a last known location. For example, when an autonomous drone 100 is docked on a landing pad 200 and the sensors in the sensor suite 101 initialize, the autonomous drone 100 can determine the current location of the autonomous drone 100 by receiving transmitted mission data 116 from the landing pad 200 which includes the current position of the autonomous drone 100 on a dimensional layout 600. In some examples, the current location of the autonomous drone 100 while docked on a landing pad 200 can be a last known location. In some examples, the position of the landing pad 200 on the dimensional layout 600 can be the last known location. The object detection model 800 can determine a location of an inventory shelving unit 301 in an image frame 903 by determining the distance of the inventory shelving unit 301 in the image frame 903 from the last known location.

Once the object detection model 800 determines the inventory shelving unit 301 in the image frames 903 is associated with an inventory shelving unit 301 on a dimensional layout 600, the object detection model 800 can determine the inventory shelving unit 301 is an object of interest 900. An object of interest 900 can be any object which can indicate a location on a dimensional layout 600 of the warehouse environment 300. Example objects of interest 900 can include any object in a warehouse environment 300 that possesses physical characteristics (e.g., height, width, depth, orientation) which can be associated with a specific location within the warehouse environment 300. In some examples, object of interest 900 is a portion of an inventory shelving unit 301 in the warehouse environment 300.

Once the object detection model 800 has determined an object is an object of interest 900, a location anchor 901 can be generated. A location anchor 901 can be an identifier that provides specific location data (e.g., a position on a dimensional layout 600) to an autonomous drone 100 when perceived by the object detection model 800. Data indicative of the location anchor 901 can be stored in a data structure onboard the autonomous drone 100, encoded in map data 201, and/or communicated to another computing system. In some examples, location anchors 901 can be embedded within the dimensional layout 600 of the warehouse environment 300. In some examples, location anchors 901 can be synchronized with location labels. In some examples, the object detection model 800 can determine the location of an inventory shelving unit 301 by determining the location label corresponds to a location on the dimensional layout 600.

In some examples, the object detection model 800 can generate a location anchor 901 based on the object of interest, wherein the object of interest comprises warehouse infrastructure, and wherein the location anchor 901 is associated with a location within the warehouse environment 300. In some examples, the localization system 108 can determine a location of the autonomous drone within the warehouse environment based on the location anchor 901. In some examples, flight planning model 801 can generate a flight plan for the autonomous drone 100 based on the mission data 116, the location anchor 901, and location of the autonomous drone 100.

In some examples, the object detection model 800 can generate a location anchor 901 based on the object of interest 900. In some examples, the object detection model 800 can determine, using a machine-learned model, physical characteristics associated with an object in the sensor data 115. In some examples, the object detection model 801 can determine, using the machine-learned, the object in the sensor data 115 is the object of interest 900 based on the physical characteristics. In some examples, the object detection model 801 can determine, using the machine-learned model, a location of the object of interest 900.

In some examples, location anchors 901 can provide precise positional information on a dimensional layout 600. In some examples, location anchors 901 can provide relative positional information on a dimensional layout 600. In other examples, multiple location anchors 901 can provide more accurate positional information on a dimensional layout 600. Location anchors 901 can include coordinates, a numbered point, cross section, or any type of location data which represents a position on a dimensional layout 600.

In some examples, location anchors 901 can be generated to reflect the location or position of an obstacle. An obstacle can include pallets, utility carts or dollies, totes, bins, etc., or any object which can disrupt the flight plan 303 of an autonomous drone 100. In some examples, the object detection model 800 can generate an obstacle label for objects determined to be an obstacle. In other examples, location anchors 901 which represent obstacles can be used by the localization system 108 to localize the autonomous drone 100.

In some examples, an obstacle map can be generated which includes location anchors 901 that represent obstacles. In some examples, the obstacle map can be included in the dimensional layout 600. In other examples, the obstacle map can be a separate map. In some examples, the obstacle map can be updated to reflect new obstacles that have a generated location anchor 901. In other examples, the obstacle map can be updated to reflect that an obstacle and a corresponding location anchor 901 are no longer present in the warehouse environment 300. In some examples, the obstacle map can be included in map data 201.

In some examples, location anchors 901 can update a dimensional layout 600. For example, as the object detection model 800 processes image frames 903 and generates location anchors 901, the dimensional layout 600 can be updated to reflect the location anchors 901. In some examples, the dimensional layout 600 can include multiple location anchors 901. In some examples, the location anchors 901 can be updated to reflect a change in the dimensional layout 600. In other examples, a change in the dimensional layout 600 can cause the object detection model 800 to generate new location anchors 901 which reflect the change in the dimensional layout 600.

The localization system 108 can utilize location anchors 901 to determine a location of the autonomous drone 100 within the warehouse environment 300. In some examples, the localization system 108 can determine its location by perceiving a location anchor 901. In some examples, the localization system 108 can determine the location of the autonomous drone 100, by generating location anchors 901. In other examples, the localization system 108 can determine the location of the autonomous drone 100 by comparing the distance between multiple location anchors 901 as the autonomous drone 100 flies throughout the warehouse environment 300.

In some examples, the location anchors 901 can be used by the localization system 108 to localize the autonomous drone 100. For example, once the object detection model 800 has generated a location anchor 901, the localization system 108 can determine the location of the autonomous drone 100 by determining the distance of the autonomous drone 100 from the location anchor 901. In some examples, the localization system 108 can determine the location of the autonomous drone 100 by determining the distance of the autonomous drone 100 from multiple location anchors 901. In some examples, the localization system 108 can determine the location of the autonomous drone 100 by determining the distance of a location anchor 901 from an inventory item 302.

The localization 108 system can utilize location anchors 901 and mission data 116 to localize the autonomous drone 100. For example, when the autonomous drone 100 receives mission data 116 from a landing pad 200, the autonomous drone 100 can determine its current position on the dimensional layout 600. In some examples, the object detection model 800 can generate a location anchor 901 for the landing pad 200. In some examples, the localization system 108 can determine the location of the autonomous drone 100 based on a location anchor 901 for the landing pad 200. In some examples, the autonomous drone 100 can receive location anchors 901 from a landing pad 200 through the transmitted mission data 116.

In some examples, the mission data 116 is obtained from a drone landing pad 200. In some examples, the mission data 116 is indicative of a region of the warehouse environment 300. In some examples, object detection model 800 can obtain mission data 116, wherein the mission data 116 is indicative of a dimensional layout 600 of the warehouse environment 300. In some examples, the object detection model 800 can determine a position on the dimensional layout 600 of the warehouse environment 300 that corresponds to the location anchor 901. In some examples, the localization system 108 can determine the location of the autonomous drone 100 based at least in part on the location anchor 901 and dimensional layout 600 of the warehouse environment 300.

In some examples, the localization system 108 can utilize location anchors 901 and inventory data 203 to localize the autonomous drone 100. For example, the autonomous drone 100 can receive the expected location of inventory items 302 within the inventory data 203 and determine the location anchor 901 matches the inventory shelving unit 301 that is expected to store the inventory item 302. In some examples, the object detection model 800 can generate a location anchor 901 based on determining the inventory shelving unit 301 expected to store an inventory item 302 is the inventory shelving unit 301 in the image frames 301. In some examples, the autonomous drone 100 can obtain inventory data 203 by scanning inventory items 302, wherein the inventory items 302 are indicative of the mission data 116.

In some examples, the autonomous drone 100 can obtain inventory data 203 by scanning inventory items 302 using a first camera 106. In some examples, first sensor data 115 is indicative of at least one of the one or more inventory items 302, wherein the first camera 106 includes a wide angle view of the inventory items 302. In some examples, the autonomous drone 100 can obtain inventory data 203 by scanning inventory items 302 using a second camera 106. In some examples second sensor data 115 is indicative of a barcode 400 on the inventory items 302, wherein the second camera 106 includes a narrow angle view of the barcode 400. In some examples, the autonomous drone 100 can obtain inventory data 203 by scanning inventory items 302. In some examples, the autonomous drone 100 can determine that an inventory item 302 is associated with a misslot or a rescan based on the first and second sensor data. Misslots can include inventory items 302 which is located in a different location (e.g., slot) than what was indicated in the inventory data 203. In some examples, a misslot can include inventory items 302 in the wrong location (e.g., slot).

In some examples, location anchors 901 can be utilized by other autonomous drones 100 in the warehouse environment 300. For example, the autonomous drone 100 can transmit updated mission data 116 to a landing pad 200 including location anchors 901. In some examples, location anchors 901 can be transmitted within an updated dimensional layout 600. In some examples, location anchors 901 can be transmitted as labeled image frames 903. The location anchors 901 can be stored on the landing pad 200 and transmitted to a second autonomous drone 100 that docks on the landing pad 200.

In some examples the localization system 108 can store location anchors 900. For example, the localization system 108 can store location anchors 900 to quickly determine the location of the autonomous drone 100 in the surrounding warehouse environment 300. In some examples, the object detection model 800 can output location anchors 901 to the landing pad 200. For instance, the landing pad 200 can receive location anchors 901 within updated mission data 116. In some examples, a second autonomous drone 100 can receive location anchors 901 from first autonomous drone 100 by obtaining updated mission data 116 including the location anchors 901.

In some examples, location anchors 901 can be used by a flight planning system 109 to generate flight plans 303 for the autonomous drone 100. In some examples, the flight planning system 109 system can receive an updated dimensional map 600 which includes the location anchors 901. An example of the flight planning system 109 using location anchors 901 to generate flight plans is shown in FIG. 10.

FIG. 10 is a block diagram of an example computing system for autonomous drone flight planning according to some implementations of the present disclosure. In FIG. 10 at a time after the object detection model 800 has generated location anchors 900 and the localization system 108 has localized the autonomous drone 100, the flight planning model 801 can receive location anchors 901 and generate flight plans 303 for the autonomous drone 100. In some examples, the flight planning model 801 can receive a dimensional layout 600 which includes location anchors 901 and utilize the location anchors 901 and dimensional layout 600 to generate flight plans 303. In some examples, the flight planning model 801 can determine the current position of the autonomous drone 100 based on the location anchors 901 and the dimensional layout 600. In other examples, the flight planning model 801 can receive mission data 116 and generate a flight plan 303 using the mission data 116, current location of the autonomous drone 100, the location anchors 901 and the dimensional layout 600.

A flight plan 303 can include one or more trajectories (e.g., flight trajectories) that indicate a path for the autonomous drone 100 to follow. A trajectory can be of a certain length or time range. The length or time range can be defined by the computational planning horizon of the flight planning system 109. A trajectory can be defined by one or more waypoints (with associated coordinates). The way points(s) can be future locations(s) for the autonomous drone 100. The flight plans 303 can be continuously generated, updated, and considered by the autonomy system 107.

In some examples, the flight planning model 801 can generate flight plans 303 to scan inventory items 302 throughout the warehouse environment 300. For example, the flight planning model 801 can utilize mission data 116 including the location of inventory items 302 to be scanned throughout the warehouse environment 300. In some examples, the flight planning model 801 can generate flight plans 303 indicative of the region where inventory items 302 to be scanned are located. In some examples, the flight planning model 801 can generate updated flight plans 303 to rescan missed inventory items 302. In some examples, the flight planning model 801 can generate updated flight plans 303 to scan misslotted inventory items 302. In other examples, the flight planning model 801 can generate updated flight plans 303 after avoiding an obstacle.

In some examples, the flight planning model 801 can receive a current location of the autonomous drone 100, location anchors 901 on a dimensional layout 600, and generate a trajectory from the current location of the autonomous drone 100 to a target location. In some examples, the target location can include the location of an inventory item 302 to be scanned. In some examples, the target location can include a landing pad 200.

In some examples, the flight planning model 801 can determine an initial trajectory by determining direction and distance from the current position of the autonomous drone 100 to the location anchor 901 on a dimensional layout 600. In some examples, the flight planning model 801 can generate a flight plan 303 which includes multiple location anchors 901 by determining trajectories that lead from one location anchor 901 to another location anchor 901 on a dimensional layout 600.

In some examples, the flight planning model 801 can generate a flight plan 303 based only on the dimensional layout 600. For example, if the object detection model 800 does not generate any location anchors 901 and the flight planning model 801 only receives the current location of the autonomous drone 100 based on a last known location, the flight planning model 801 can utilize the last known location and the dimensional layout 600 to generate a flight plan 303.

In some examples, the autonomous drone 100 can continuously localize based on location anchors 901 that are included in the flight plan 303. For example, the autonomous drone 100 can perceive location anchors 901 as it executes a flight plan 303 and the localization system 108 can continuously localize the autonomous drone 100 throughout the flight plan 303. In some examples, the flight planning model 801 can determine flight plans 303 that include more location anchors 901 are more optimal than flight plans 303 that include less location anchors 901. In some examples, the flight planning model 801 can determine that flight plans 303 that include less location anchors 901 are more optimal than flight plans 303 that include more location anchors 901. For example, the flight planning model 801 can determine that flight plans 303 that include location anchors 901 which represent obstacles in the warehouse environment 300 are less optimal than a flight plan 303 with fewer location anchors 901 that do not contain any obstacles. The flight planning model 801 can generate flight plans 303 as the localization system 108 continuously localizes the autonomous drone 100.

In some examples, the flight planning model 108 can generate a dock flight plan 303, wherein the dock flight plan 303 is indicative of the autonomous drone 100 navigating to a drone landing pad 200. In some examples, the autonomous drone 100 can transmit updated mission data 116 to the landing pad 200, wherein the updated mission data 116 is indicative of the inventory items 302 scanned by the autonomous drone 100.

In some examples, the flight planning model 801 can generate flight plans 303 that allow for increased localization. For example, the flight planning model 801 can determine that there are no practical flight plans 303 which include location anchors 901. In some examples, the flight planning model 801 can generate a flight plan 303 to generate location anchors 901 to increase localization for the autonomous drone 100.

In some examples, the flight planning model 801 can update a flight plan 303. For example, as the autonomous drone 100 executes a flight plan 303 the autonomous drone 100 may encounter an obstacle and perform active avoidance. Active avoidance can include directing the autonomous drone 100 to avoid an obstacle in the warehouse environment 300. In some examples, active avoidance can prevent the autonomous drone from colliding with an object in the warehouse environment 300. In some examples, the autonomous drone 100 will need to localize to determine a trajectory after avoiding an obstacle. In some examples, the flight planning model 801 can generate an updated flight plan 303 that includes the nearest location anchor 901 from the original flight plan 303. In some examples, the updated flight plan 303 may include location anchors 901 not included in the original flight plan 303.

In some examples, the flight planning model 801 can receive new location anchors 901 as the autonomous drone 100 executes a flight plan 303 and generate an updated flight plan 303. For example, the flight planning model 801 can determine a new location anchor 901 yields a shorter flight distance than a previous flight plan 303 generate an updated flight plan 303 which includes a direction of travel towards the new location anchor 901. In some examples, the flight planning model 801 can determine a new location anchor 901 will yield a longer travel distance and ignore the new location anchor 901.

In some examples, the object detection model 800 can generate new location anchors 901 as the autonomous drone 100 executes a flight plan 300 and provide the location anchors 901 to the flight planning model 801. In some examples, the flight planning model 801 can use the newly generated location anchors 901 for future flight plans 303.

In some examples, the flight planning model 801 can generate a flight plan 303 that includes location anchors 900. For example, the flight planning model 801 can generate a trajectory which includes a first direction of travel towards a location anchor 901. In some examples, the localization system 108 can continuously localize the autonomous drone 100 by executing a flight plan 303 that includes location anchors 901.

In some examples, the flight planning model 801 can utilize location anchors 901 to generate a more optimal flight plan 303. For example, the flight planning model 801 can determine the distance between multiple location anchors 901 will yield a shorter flight distance than a previous flight plan 303 and generate an optimized flight plan 303 which includes the location anchors 901. In some examples, the flight planning model 801 can determine the distance between multiple location anchors 901 will yield a longer flight distance than a previous flight plan 303 generate an optimized flight plan 303 which includes different location anchors 901.

In some examples, the flight planning model 801 can determine a flight plan 303 does not include any location anchors 901. The flight planning model 801 can generate a flight plan 303 for the autonomous drone 100 which will generate location anchors 901 for future use. In some examples, the flight planning model 801 can determine a flight plan 303 can be optimized and generate a flight plan 303 to cause the object detection model 800 to generate a location anchor 901. In some examples, the fight planning model 801 can iterate through flight plans 303 which do not include location anchors 901 until location anchors 901 are generated. In some examples, the flight planning model 801 can determine the most optimal flight plan 303 does not include location anchors 901.

In some examples, the flight planning model 801 can generate, using the location anchor 901, an initial trajectory of the autonomous drone 100 wherein the initial trajectory is indicative of a first direction of travel based on the location anchor 901.

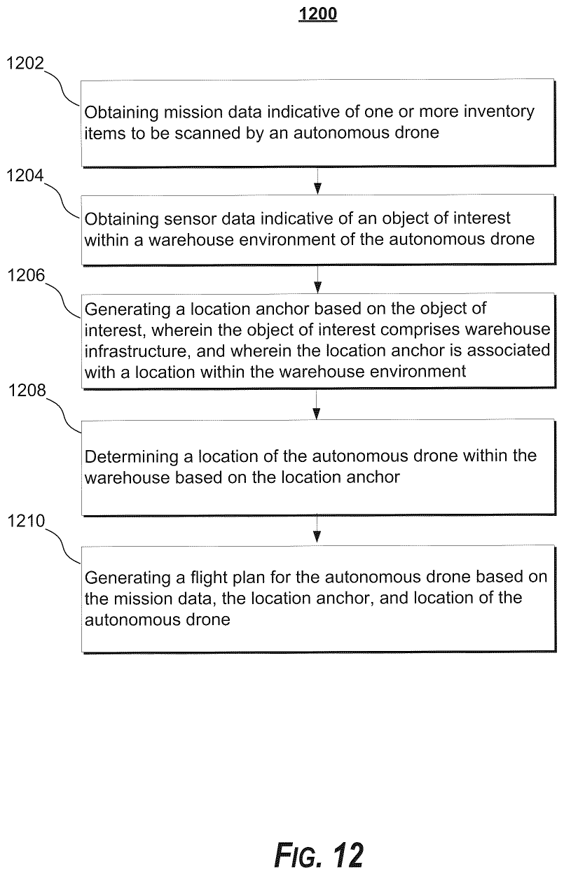

FIG. 12 is a flow chart of an example method for autonomous drone localization using location anchors, according to some implementations of the present disclosure. One or more portion(s) of the method 1200 can be implemented by a computing system that includes one or more computing devices such as, for example, the computing systems described with reference to the other figures (e.g., autonomous drone 100, autonomy system 107, remote system(s) 700, a system of FIGS. 1, 2, 7, etc.). Each respective portion of the method 1200 can be performed by any (or any combination) of one or more computing devices. Moreover, one or more portion(s) of the method 1200 can be implemented on the hardware components of the device(s) described herein (e.g., as in FIGS. 1, 2, 7 etc.), for example, to localize an autonomous drone 100 and generate a flight plan 303 with respect to the same.

FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of method 1200 can be performed additionally, or alternatively, by other systems.

At 1202, the method 1200 includes obtaining mission data indicative of one or more inventory items to be scanned by an autonomous drone. For instance, a computing system (e.g., on board the autonomous drone 100) can obtain mission data 116 from a landing pad 200. The mission data 116 can include data indicating inventory items 302 to be scanned by the autonomous drone 100 and the expected location of the inventory items 302.

At 1204, the method 1200 includes obtaining sensor data indicative of an object of interest within the surrounding warehouse environment of the autonomous drone. For instance, a computing system (e.g., onboard the autonomous drone 100) can obtain image frames 903 from one or more cameras 106 onboard the autonomous drone 100. The image frames 903 can include a plurality of image frames 903 at a plurality of times.

At 1206, the method 1200 includes generating a location anchor based on the object of interest, wherein the object of interest includes warehouse infrastructure, and wherein the location anchor is associated with a location within the warehouse environment. For instance, the computing system can access a machine-learned object detection model 800 from an accessible memory (e.g., onboard the autonomous drone 100). The object detection model 800 can generate a location anchor 901 by determining the object of interest 900 can be associated with a position on a dimensional layout 600 of the warehouse environment 300.

In some examples, the location anchor 901 can indicate an associated position or location on a dimensional layout 600. In some examples, the location anchor 901 can be embedded within the dimensional layout 600. In some examples, the location anchor 901 can provide locational data to the object detection model 800 when perceived by the autonomous drone 100 by associating the location anchor 901 with an object on a dimensional layout 600. In other examples, a position or location of a location anchor 901 on the dimensional layout 600 can indicate a position or location in the warehouse environment 300.

At 1208, the method 1200 includes determining a location of the autonomous drone within the warehouse environment based on the location anchor. For instance, the computing system can access a localization system 108 accessible memory (e.g., onboard the autonomous drone 100). The localization system 108 can include a machine-learned object detection model 800. In some examples, the object detection model 800 can determine a location of an object of interest 900 and generate a location anchor 901. In some examples, the location anchor 901 can provide the localization system 108 with a location of the object being perceived by the autonomous drone 100. In some examples, the localization system 108 can determine the location of the autonomous drone 100 by determining the distance of the autonomous drone 100 from the location anchor 901.

In some examples, the localization system 108 can determine the location of the autonomous drone 100 by determining the distance of the autonomous drone 100 from multiple location anchors 901. In some examples, the localization system 108 can determine the location of the autonomous drone 100 by determining a relative or exact location from a location anchor 901.

At 1210, the method 1200 includes generating a flight plan for the autonomous drone based on the mission data, the location anchor, and the location of the autonomous drone. For instance, the computing system can access a localization system 108 and a flight planning system 109 from accessible memory (e.g., onboard the autonomous drone 100). In some examples, the localization system 108 can generate location anchors 901 and localize the autonomous drone 100 by determining a location of the autonomous drone 100.

In some examples, the flight planning system 801 can include a machine-learned flight planning model 801. In some examples, the machine-learned flight planning model 801 can obtain mission data 116 which includes the inventory items 302 to be scanned by the autonomous drone 100 and an expected location of the inventory items 302 within the warehouse environment 300. In some examples, the flight planning model 801 can receive the current location of the autonomous drone 100 and location anchors 901 from the localization system 108.

In some examples, the flight planning model 801 can generate a flight plan 303 which directs the autonomous drone 100 to the region of the warehouse environment 300 where inventory items 302 to be scanned are expected to be located. In some examples, the flight planning model 801 can determine a trajectory of the autonomous drone 100 from the location of the autonomous drone 100 from/to a location anchor 901. In some examples, a flight plan 303 can be generated which includes multiple trajectories which directs the autonomous drone 100 to the expected location of inventory items 302 to be scanned in the warehouse environment 300. In some examples, the flight plans 303 include trajectories which cause the object detection model 800 to perceive a location anchor 901. In other examples, the flight planning model 801 can generate a flight plan 303 which directs the autonomous drone 100 towards (or away from) a location anchor 901.

FIG. 13 is a representation of example landing pads accommodating multiple autonomous drones in a warehouse environment. As further described herein, a first flight planning model 801 can generate a first flight plan 303 for a first autonomous drone 1301 docked on a first landing pad 1303 in the warehouse environment 300. In some examples, the first landing pad 1303 can be affixed to an inventory shelving unit 1305. In some examples, the first autonomous drone 1301 docked on a first landing pad 1303 can take off from the first landing pad 1303 to execute a first flight plan. In some examples, a second flight planning model can generate a second flight plan to dock on a first landing pad 1303 for a second autonomous drone 1302 in the warehouse environment 300. In some examples, the second autonomous drone 1302 can execute the second flight plan and dock on the first landing pad 1303 where the first autonomous drone 1301 was previously docked.

In some examples, the warehouse environment can include a second landing pad 1304 where an autonomous drone 1301, 1302 can dock. In some examples, the second landing pad 1304 can be affixed to and inventory shelving unit 1306. For example, the first autonomous drone 1301 that was previously docked on the first landing pad 1303 can dock on another, second landing pad 1304 in the warehouse environment 300. In some examples, the second autonomous drone 1302 previously docked on the first landing pad 1303 can also dock on the second landing pad 1304 when unoccupied by another autonomous drone 1301. In other examples, the autonomous drones 1301, 1302 can dock on any landing pad 1303, 1304 in the warehouse environment 300.

In some examples, a flight planning model can generate a docking flight plan 303 for the autonomous drone 1301, 1302 to dock on the closest landing pad 1303, 1304 after executing an inventory scanning mission. In some examples, a flight planning model can generate a docking flight plan 303 for the autonomous drone 1301, 1302 to dock on a pre-determined landing pad 1303, 1304. In some examples, a flight planning model can dynamically generate a docking flight plan for the autonomous drone 1301, 1302 to dock on a landing pad 1303, 1304 while the autonomous drone 1301, 1302 is in-flight. In other examples, a flight planning model can generate a docking flight plan for the autonomous drone 1301, 1302 to dock on the nearest unoccupied landing pad 1303, 1304.

A warehouse environment 300 can have a plurality of autonomous drones 1301, 1302 and a plurality of landing pads 1303, 1304. In some examples, the plurality of landing pads 1303, 1304 can communicate with the plurality of autonomous drones 1301, 1302. In some examples, the landing pads 1303, 1304 can communicate with autonomous drones 1301, 1302 while the autonomous drones 1301, 1302 are docked on landing pads 1303, 1304. In other examples, the landing pad 1303, 1304 can communicate with the autonomous drones 1301, 1302 as it flies throughout the warehouse environment 300.

The autonomous drones 1301, 1302 and the landing pad 1303, 1304 can each include communication interfaces 710 and 726, respectively. The communication interfaces 718 and 726 can be used to communicate with each other or one or more other systems or devices, including systems or devices that are remotely located from the autonomous drones 1301, 1302 or the landing pads 1303, 1304. The communication interfaces 718 and 726 can include any circuits, components, software, etc. for communicating with one or more networks (e.g., the network(s) 702). In some implementations, the communication interfaces 718, 726 can include, for example, one or more of a communications controller, receiver, transceiver, transmitter, port, conductors, software or hardware for communicating data.

In some examples, the communication interfaces 718 and 726 of the autonomous drones 1301, 1302 and landing pads 1303, 1304 can communicate through physical contact or wired connection while the autonomous drones 1301, 1302 are docked on the landing pads 1303, 1304. For example, the communication interface 726 can include a mechanism (e.g., data pins) to transfer data to the communication interface 718. In some examples, when the autonomous drones 1301, 1302 make contact with the landing pads 1303, 1304 (e.g. data pins) a high-speed telecommunication channel can be established to allow for communication between the autonomous drones 1301, 1302 and the landing pads 1303, 1304.

In some examples, the communication interfaces 718 and 726 of the autonomous drones 1301, 1302 and landing pads 1303, 1304 can communicate wirelessly as the autonomous drone 1301, 1302 flies throughout the warehouse environment 300. For example, the communication interface 726 can emit a wireless signal (e.g., wireless local area network (WLAN)) which can be received by the communication interface 718 of the autonomous drones 1301, 1302 as the autonomous drones 1301, 1302 flies throughout the warehouse environment 300. In some examples, a connection can be established between the communication interfaces 718 and 726 when the signal strength emitted from communication interface 726 reaches a certain threshold. In some examples, the communication interface 726 can include a pool of internet protocol (IP) addresses that are dynamically assigned to the communication interface 718 of an autonomous drone 1301, 1302 in range of the wireless signal.

The communication interfaces 718 and 726 can transition between contact (e.g., wired) communication and wireless communication. For example, when an autonomous drones 1301, 1302 takes off to execute a flight plan 303, the communication interface 726 of landing pads 1303, 1304 can beacon (e.g., regular transmissions to inform devices about available access points) communication interfaces 718 of autonomous drones 1301, 1302. In some examples, the communication interfaces 726 of the autonomous drones 1301, 1302 can beacon every 5 seconds to detect an autonomous drone 1301, 1302 in range of the emitted signal. In some examples, the communication interfaces 718 and 726 can automatically activate a contact (e.g., wired) connection when the autonomous drone 1301, 1302 docks on a landing pad 1303, 1304.

In some examples, the communication interfaces 718 and 726 can maintain a constant connection. For example, a warehouse environment 300 can include multiple landing pads 1303, 1304 located throughout the warehouse environment 300. When the autonomous drones 1301, 1302 flies throughout the warehouse environment 300, the wireless signal emitted from a first communication interface 726 of a first landing pad 1303 may decrease while the wireless signal emitted from a second communication interface 726 of a landing pad 1304 may increase. In some examples, the communication interfaces 718 and 726 may maintain a constant connection by seamlessly switching between different landing pads 1303, 1304 as it flies throughout the warehouse environment 300. In some examples, the communication interfaces 718 and 726 can maintain a connection when the autonomous drones 1301, 1302 dock on a landing pad 1303, 1304 and activate a contact (e.g., wired) connection.

In some examples, the plurality of landing pads 1303, 1304 in the warehouse environment 300 can communicate with each other. For instance, the plurality of landing pads 1303, 1304 can be communicatively coupled over the one or more networks 702. In some examples, the communication interfaces 726 of the plurality of landing pads 1303, 1304 can pass messages to each other over the one or more networks 702.

In some examples, a landing pad 1303 can communicate to other landing pads 1304 in the warehouse environment 300 that an autonomous drone 1301, 1302 is docked. For example, the landing pad 1303 can communicate over the one or more networks 702 messages to other landing pads 1304 in the warehouse environment 300 indicating that an autonomous drone 1301, 1302 is docked. In some examples, a landing pad 1303 can communicate over the one or more networks 702 messages to other landing pads 1304 in the warehouse environment 300 indicating that an autonomous drone 1301, 1302 is wirelessly connected to the landing pads 1303, 1304 as the autonomous drone 1301, 1302 flies through the wireless signal range of the landing pads 1303, 1304.

In some examples, the plurality of landing pads 1303, 1304 can include a leader landing pad 1303, 1304 that propagates messages to other landing pads 1303, 1304 in the warehouse environment 300. For example, the leader landing pad 1303, 1304 can be the source of truth for orchestrating the dissemination of mission data 116 to the other landing pads 1303, 1304 in the warehouse environment 300. For example, the leader landing pad 1303, 1304 can ensure that an autonomous drone 1301 which is executing a docking flight plan 303 does not collide with another autonomous drone 1302 by docking on a landing pad 1303 which already has an autonomous drone 1301 docked. In some examples, the mission data 116 is obtained by the first autonomous drone 1301 and a second autonomous drone 1302 from the landing pad 1303. In some examples, the mission data 116 is obtained by the first autonomous drone 1301 and a second autonomous drone 1302 from the landing pad 1304. In some examples, the leader landing pad 1303, 1304 can store a copy of all data which had been transmitted to other landing pads 1303, 1304 in the warehouse environment 300. In other examples, the leader landing pad 1303, 1304 can orchestrate the flight plans 303.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting.

What is claimed is:

1. A computer-implemented method comprising:
obtaining mission data indicative of one or more inventory items to be scanned by an autonomous drone;
obtaining sensor data indicative of an object of interest within a warehouse environment of the autonomous drone;
generating a location anchor based on the object of interest, wherein the object of interest comprises warehouse infrastructure, and wherein the location anchor is associated with a location within the warehouse environment;
determining a location of the autonomous drone within the warehouse environment based on the location anchor; and
generating a flight plan for the autonomous drone based on the mission data, the location anchor, and location of the autonomous drone.

2. The computer-implemented method of claim 1, wherein the mission data is obtained from a landing pad.

3. The mission data of claim 2, wherein the mission data is indicative of a region of the warehouse environment.

4. The computer-implemented method of claim 1, wherein determining the location of the autonomous drone further comprises:
obtaining map data, wherein the map data is indicative of a dimensional layout of the warehouse environment;
determining a position on the dimensional layout of the warehouse environment that corresponds to the location anchor; and
determining the location of the autonomous drone based on the location anchor and dimensional layout of the warehouse environment.

5. The computer-implemented method of claim 1, wherein generating the location anchor based on the object of interest comprises:
determining, using a machine-learned model, physical characteristics of an object in the sensor data;
determining, using the machine-learned model, the object in the sensor data is the object of interest based on the physical characteristics; and
determining, using the machine-learned model, a location of the object of interest.

6. The computer-implemented method of claim 1, wherein generating the flight plan further comprises, generating, using the location anchor, an initial trajectory of the autonomous drone wherein the initial trajectory is indicative of a first direction of travel based on the location anchor.

7. The object of interest of claim 1, wherein the object of interest is a portion of an inventory shelving unit in the warehouse environment.

8. The computer-implemented method of claim 1, further comprising obtaining inventory data by scanning inventory items, wherein the inventory items are indicative of the mission data.

9. The computer-implemented method of claim 8, wherein obtaining inventory data by scanning inventory items comprise:
obtaining, using a first camera, first sensor data indicative of at least one of the one or more inventory items, wherein the first camera includes a wide angle view of the inventory items;
obtaining, using a second camera, second sensor data indicative of a barcode on the inventory items, wherein the second camera includes a narrow angle view of the barcode; and
determining that an inventory item is associated with a misslot or a rescan based on the first and second sensor data.

10. The computer-implemented method of claim 2 further comprising:
generating a dock flight plan, wherein the dock flight plan is indicative of the autonomous drone navigating to the landing pad; and
transmitting updated mission data to the landing pad, wherein the updated mission data is indicative of the inventory items scanned by the autonomous drone.

11. The computer-implemented method of claim 2, wherein the autonomous drone is a first autonomous drone, wherein the mission data is obtained by the first autonomous drone and a second autonomous drone from the landing pad.

12. A computing system for an autonomous drone, comprising:
one or more processors; and
one or more computer-readable media storing instructions that are executable to cause the autonomy system to perform operations, the operations comprising:
obtaining mission data indicative of one or more inventory items to be scanned by the autonomous drone;
obtaining sensor data indicative of an object of interest within a warehouse environment of the autonomous drone;
generating a location anchor based on the object of interest, wherein the object of interest comprises warehouse infrastructure, and wherein the location anchor is associated with a location within the warehouse environment;
determining the location of the autonomous drone within the warehouse environment based on the location anchor; and
generating a flight plan based on the mission data, the location anchor, and the location of the autonomous drone.

13. The computing system of claim 11, wherein the mission data is obtained from a landing pad.

14. The mission data of claim 12, wherein the mission data is associated with of a region of the warehouse environment.

15. The computing system of claim 11, wherein determining the location of the autonomous drone further comprises:
obtaining map data, wherein the map data is indicative of a dimensional layout of the warehouse environment;
determining a position on the dimensional layout of the warehouse environment that corresponds to the location anchor; and
determining the location of the autonomous drone based on the location anchor and dimensional layout of the warehouse environment.

16. The computing system of claim 11, wherein generating a location anchor based on the object of interest comprises:
determining, using a machine-learned model, physical characteristics associated with an object in the sensor data;
determining, using the machine-learned, the object in the sensor data is the object of interest based at least in part on the physical characteristics; and
determining, using the machine-learned model, a location of the object of interest.

17. The computing system of claim 11, wherein generating a flight plan further comprises, generating, using the location anchor, an initial trajectory of the autonomous drone wherein the initial trajectory is indicative of a first direction of travel based on the location anchor.

18. The object of interest of claim 11, wherein the object of interest is a portion of an inventory shelving unit in the warehouse environment.

19. The computing system of claim 11, further comprising obtaining inventory data by scanning inventory items, wherein the inventory items are indicative of the mission data.

20. The computing system of claim 18, wherein obtaining inventory data by scanning inventory items comprise:
obtaining, using a first camera, first sensor data indicative of at least one of the one or more inventory items wherein the first camera includes a wide angle view of the inventory items;
obtaining, using a second camera, second sensor data indicative of a barcode on the inventory items, wherein the second camera includes a narrow angle view of the barcode; determining that an inventory item is associated with a misslot or rescan based on the first and second sensor data.
